(19) United States
(12) Patent Application Publication
(10) Pub. No.: US 2005/0256681 A1
(43) Pub. Date: Nov. 17, 2005

(54) Metering device and process to record engine hour data

(76) Inventors: Brett A. Brinton, Bellevue, WA (US); Charles Michael McQuade, Issaquah, WA (US)

Correspondence Address: LAW OFFICES OF RONALD M ANDERSON, 600 108TH AVE, NE, SUITE 507, BELLEVUE, WA, 98004, US

(21) Appl. No.: 11/133,139

(22) Filed: May 18, 2005

Related U.S. Application Data
(63) Continuation-in-part of application No. 10/915,957, filed on Aug. 11, 2004.
Application No. 10/915,957 is a continuation-in-part of application No. 10/219,892, filed on Aug. 15, 2002, now Pat. No. 6,804,626.
Application No. 10/219,892 is a continuation-in-part of application No. 09/951,104, filed on Sep. 11, 2001, now Pat. No. 6,671,646.

(51) Int. Cl. G06F 11/30

(52) U.S. Cl. 702/182

(57) ABSTRACT

A handheld, portable device (20, 140 , or 140′ ) is used to store data that indicate an operator was sufficiently close to each of a plurality of components during a safety inspection to actually inspect the components. The portable device includes a sensor (46) that detects tokens (12, 16, 24), such as radio frequency identification tags, which are affixed adjacent to the components. Messages (58) appearing on a display (40, 152) of the portable device prompt the operator to proceed to each checkpoint, determine a state of the component disposed there, and if the component is not operating properly, indicate a plurality of predefined conditions from which the operator can choose to identify the observed condition of the component. The state and condition of each component entered during the safety inspection are stored as data that are subsequently transferred to a remote data storage site over a wire or wireless link.

### RELATED APPLICATIONS

This application is a continuation-in-part of prior co-pending application Ser. No. 10/915,957 , filed on Aug. 11, 2004 , which itself is a continuation-in-part of prior co-pending application Serial No. 10/219,892 , filed on Aug. 15, 2002 and now issued as U.S. Pat. No. 6,804,626 on Oct. 12, 2004 , which itself is a continuation-in-part of prior application Ser. No. 09/951,104 , filed on Sept. 11, 2001 and now issued as U.S. Pat. No. 6,671,646 on Dec. 30, 2003 , the benefit of the filing dates of which is hereby claimed under 35 U.S.C. § 120.

### FIELD OF THE INVENTION

The present invention generally provides evidence that a person was physically at a designated position adjacent to a component of a machine or apparatus, and more specifically, provides an electronic record indicating when the person was physically disposed to carryout a safety inspection and to indicate a safety related operating condition of the component.

### BACKGROUND OF THE INVENTION

A recent network television news program reported that nearly 40 percent of big rig tractor-trailers were so dangerous that they would be ordered off the road if inspected. While not all accidents involving commercial trucks and trailers are the result of defective equipment that could be identified in a safety inspection, a significant reduction in accidents is likely to be achieved by taking steps to ensure that key components of such equipment are inspected.

In response to the public's concern for the increase in large vehicle traffic on our nation's highways and the increased frequency of reported accidents involving commercial vehicles, Congress adopted the Motor Carrier Safety Improvement Act of 1999 (PL 106-159). Pursuant to this Act, the Federal Motor Carrier Safety Administration (FMCSA) was created within the U.S. Department of Transportation (DOT). Part of the mission of this new agency is to develop a long-term strategy to “improve commercial motor vehicle, operator, and carrier safety” . It is expected that by successfully addressing these issues, the incidence of accidents by commercial carriers will be reduced.

In furtherance of its mission, the FMCSA convened a series of meetings and planning sessions with representatives from other Federal agencies, the states, and the transportation industry. Through that process, FMCSA developed a policy entitled: “2010 Strategy - Saving Lives Through Safety, Innovation, and Performance.” The primary goal of this policy is to improve transportation safety through the implementation of 31 strategic initiatives, which run the gamut from improved highway construction to better screening of drivers and equipment to detect potential equipment safety problems before they result in accidents.

The FMCSA's intention is to enhance motor carrier safety management practices through improved vehicle inspection, repair, and maintenance procedures. As acknowledged in the 2010 Strategy, “[I ] these functions are not conducted properly, driver and vehicle deficiencies can increase the potential for a crash.” Among the nine separate strategies contemplated by FMCSA to achieve this important objective is “the introduction of new technology to improve safety performance.” In stating its highest priorities, the 2010 Strategy further distills its 31 initiatives down to 13 “highest priority” strategies. Significantly, four of these highest priority strategies can be directly promoted with appropriate technology that will provide an electronic record of vehicle safety inspections and will tend to encourage such inspections. Specifically, it will be important to promote and encourage: (a) vehicle inspections with a focus on technology improvements; (b) improved safety management practices; (c) greater emphasis on technology transfer and deployment to achieve safe operating equipment; and (d) improved safety data collection and analysis.

To avoid accidents caused by defective equipment, Federal law presently requires that commercial drivers make a visual inspection of specific components on a truck (i.e., tractor and trailer), such as the brake system, fuel system, warning lights, tires, etc., performing pre- and post-trip inspections of these basic, but critical components. An exemplary vehicle inspection report listing the components and systems that must be inspected by a driver to satisfy the DOT regulations is illustrated in FIG. 7. However, under the current system, a driver is only required to fill out a paper log and keep it on file for 90 days. Many experts report that less than half of the drivers ever perform the check; instead, many drivers simply fill out the report while seated in the cab of the truck or in a coffee shop. The report is meaningless unless the listed components and systems have actually been inspected. For example, a driver who fails to actually inspect components on his vehicle will not notice that brake fluid is leaking from a hydraulic master brake cylinder. As a result, the brakes on the driver's truck may fail, potentially causing a serious accident.

A signed inspection report does not provide any assurance that a driver actually inspected the components included on the report. However, technology might provide a way to at least ensure that a driver (or other person doing a safety inspection) was physically present in the vicinity of each component requiring inspection, even if the driver is not compelled to affirmatively inspect all of the components. Most people, if required to actually walk to a component such as a tire of a truck, will then be more willing to at least look at the condition of the component, particularly if the task of indicating the condition of the component if there is a problem, is made relatively simple and efficient.

An analogous approach is employed to ensure that a night watchman visits different locations in a building. To provide evidence that he has made his rounds, the night watchman must use a key contained in a lock box at each different location to activate a handheld timekeeping device, making a record of the time that the location was visited. The night watchman thus provides proof of having visited each location for purposes of performing a security check at specified times. However, a night watchman cannot record a security violation with the handheld device, and a security check by a night watchman does not relate to making a safety inspection of a component at a specific location on a truck. Also, requiring that a key be stored in a lock box on a truck or other system that is being inspected is not practical, and it is not efficient to require a driver or other person doing a safety inspection to manually use a key or other physical object to provide proof that the person physically visited the location during the safety inspection tour.

It would be desirable for a person making a safety inspection to carry a handheld device that automatically detects when the person is in the proximity of a component included on an inspection list and enters a record of the results of the inspection in a non-volatile memory. A sensor in the handheld device should respond to a tag or transponder associated with a component being inspected when the sensor is within a predetermined distance from the tag, by recording the event and displaying a menu that prompts the operator to enter data related to a safety condition of the component. For example, once the operator is within a range appropriate to permit inspection of the tires on a truck, the handheld device should enable the person inspecting the tires to indicate: (a) that the tires appear safe; (b) that the tires need servicing but are still usable; or, (c) that the tires are too unsafe to be driven. If the component needs servicing or is unsafe to use, the operator should be able to record a reason for that determination. Since proof that an inspection was made prior to driving a vehicle and the conditions of the components that were inspected may have an important bearing on any insurance claims and/or liability in the event of an accident with the vehicle, it would also be desirable to enable the data from the handheld device to be uploaded to a geographically separate central data storage facility after the inspection is completed.

Encouraging safety inspections of other types of equipment by creating a record providing evidence that a person doing the inspection actually visited each component that must be inspected has utility in many other applications other than the transportation industry. The concept is also useful in confirming the safe operating condition of machinery and components in other systems in which accidents related to equipment malfunction and failure must be avoided. For example, such a need exists in high-risk chemical and petrochemical operations, where periodic inspections of valves, pressure vessels, gauges, and other components must be carried out to avoid potentially disastrous and costly accidents in which significant loss of life and property might occur.

Furthermore, an operational equipment inspection is another inspection that would be desirable to conduct. For example, construction equipment such as excavators, bulldozers, forklifts, backhoes, cranes, and graders are often rented or leased by construction companies, and rental charges are often based on the number of engine hours for each piece of equipment. Even if such a piece of equipment is owned by a construction company, charges to a client can be based in part on the number of engine hours required to complete a project. Engine hours can also be used as a metric for managing routine maintenance to prolong equipment life. Therefore, it is useful to keep track of the number of engine hours. Particularly where fleets of vehicles are concerned, collection of engine hour data can be tedious. Many vehicles and pieces of heavy equipment equipped with hour meters require the engine to be running, or the ignition switch to be actuated, to extract engine hour data. This means that an individual tasked with recording engine hour data must have access to the keys for each vehicle or piece of heavy equipment, and then unlock and start each vehicle or piece of heavy equipment, a time consuming process. It would be desirable to provide a system and method to facilitate collection of engine hour data in a more efficient manner. A related metric that is often desired by regulatory agencies such as the Environmental Protection Agency is idle time, referring to the number of hours an engine is operating without being under load. It would be desirable to provide a system and method to facilitate collection of idle time in conjunction with the collection of engine hour data.

### SUMMARY OF THE INVENTION

One aspect of the present invention is a metering device adapted to be logically coupled to an ignition switch used to selectively energize a prime mover, such as an engine. The metering device is configured to generate and store engine hour data. The metering device comprises a memory in which the data that can be used to determine how long the prime mover has been energized can be stored, a data interface enabling the data to be extracted from the metering device, a timer adapted to provide a time signal, and a controller. The controller, which can be implemented by a processor or an application-specific integrated circuit, is logically coupled to the memory, the data interface, and the timer, and configured to be coupled to a power supply associated with the prime mover and the ignition switch. The controller is configured implement the functions of determining when the ignition switch is in a state indicating that the prime mover is energized, using the time signal from the timer while the ignition switch is in a state indicating that the prime mover is energized to generate a first type of data that can be used to determine how long the prime mover has been energized, storing the first type of data in the memory; and responding to a request for data from the data interface by retrieving first type of data from the memory and communicating the retrieved data to the data interface for extraction.

In a particularly preferred embodiment the data interface comprises a radio frequency identification tag, such that data can be extracted from the metering device by placing a portable reader proximate the data interface, without actually requiring a physical connection between the data interface in the portable reader. It should understood however, that the present invention also encompasses embodiments in which a physical connection is required between the data interface and a portable reader to extract the data from the metering device. An IBUTTON™ computer chip is an exemplary data interface that requires a physical connection with the portable reader to extract data. Of course, conventional data ports including serial ports, parallel ports, and USB ports can be used to implement a data interface requiring a physical connection with a portable reader.

Preferably the controller is configured to collect engine hour data whenever an ignition switch controlling the prime mover is in a switched power position. In at least one embodiment the controller is configured to generate and store engine hour data having a resolution of about six minutes.

In at least one embodiment the data interface of the metering device has a limited bandwidth for communicating data to a portable reader. In such an embodiment the controller can be beneficially configured to transmit a plurality of distinct data packets in response to a single request for data.

The metering device of the present invention can be configured to collect additional types of data. For example, where an idle time sensor is incorporated into a vehicle or piece of equipment including the metering device of the present invention, the controller can be configured to produce idle time data in response to an input from an idle time sensor. Idle time sensors can be implemented as a driveline sensor responsive to the rotation of a drive shaft, a neutral start switch capable of determining when a transmission is engaged, and an inductive sensor responsive to the revolutions per minute of an engine (RPM). A non-rotating drive shaft (while an ignition switch is “on”) indicates that an engine is idling, a transmission that is not engaged (while an ignition switch is “on”) indicates that an engine is idling, and a low rpm can also indicate that an engine idling, as opposed to performing useful work (i.e. being under a load). The controller can be further configured to output idle time data as well as engine hour data in response to a request for data from a separate (preferably portable) reader.

An additional type of data the metering device of the present invention can be beneficially configured to collect is battery voltage data. When the voltage of the battery in storage changes more than a predefined amount, such a condition is indicative of either a short in the vehicle or piece of equipment the battery is associated with, or a short in the battery itself. Because the metering device of the present invention is coupled to the battery associated with the vehicle or piece of equipment the metering device is implemented in, the controller in the metering device can be configured to periodically sample the battery voltage when the control unit or ignition switch selectively controlling the prime mover is in an off position. In one embodiment, whenever the currently sampled voltage is lower than a stored voltage, the currently sampled voltage will be used to replace the stored voltage value in the memory. This data can be used to determine if the vehicle or piece of equipment requires maintenance associated with the electrical system, such as the correction of a short-circuit or the replacement of the battery itself. The controller can be configured to output battery voltage data as well as engine hour data in response to a request for data from a separate (preferably portable) reader.

Significantly, the metering device of the present invention is configured to output data even when the prime mover is not energized and the control unit or ignition switch selectively controlling the prime mover is in an off position. This is possible because the metering device is coupled to the battery associated with the vehicle (or piece of equipment) the metering device is incorporated into. Thus the metering device of the present invention can be energized using the vehicles own battery power to enable the metering device to output data in response to a request for data from a reader.

Preferably the metering device comprises a housing encapsulating the memory, the data interface, the timer, and the controller. In at least one embodiment, the memory, the data interface, and the controller collectively comprise a token. The extracted data comprises at least engine hour data, and preferably includes one or more of the following: idle time data, identification data uniquely identifying the vehicle or piece of equipment the metering device is associated with, and battery voltage data.

Yet another aspect of the present invention is directed to a method for collecting data corresponding to a prior operational status of a prime mover. Such a method includes the steps of providing a metering device that is adapted to be logically coupled to a control unit used to selectively energize a prime mover, coupling the metering device to the control unit of the prime mover such that the metering device is enabled to generate and store data corresponding to the operational status of the prime mover when the control unit is in a position indicative of the prime mover being energized, the data enabling a determination to be made as to how long the prime mover has been energized, and extracting the data from the metering device.

Preferably the data includes an identification uniquely identifying at least one of an engine, a vehicle, or piece of heavy equipment. Where the control unit comprises an ignition switch, preferably the step of extracting the data further comprises extracting the data when the ignition switch is in an off position. Preferably the data is extracted using a portable reader. In at least one embodiment the step of extracting the data comprises the step of extracting a plurality of data reads based on a single request for data.

Yet another aspect of the present invention is a method for collecting data enabling a determination to be made as to how long a prime mover has been energized. Such a method includes the steps of collecting data when a control unit configured to selectively energize the prime mover of a vehicle is in a position indicative of the prime mover being energized, storing the data in a memory, and extracting the data, such that the data can be extracted when the prime mover is not energized and when the control unit is in an off position.

In at least one embodiment the step of extracting the data comprises the step of transmitting multiple sets of data based on a single request for data. In at least one embodiment the step of extracting the data comprises the step of extracting data corresponding to idle time. Also in at least one embodiment the step of extracting the data comprises the step of extracting data indicative of a condition of a battery associated with the prime mover. Preferably the data is extracted using radio frequency identification communication.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a tractor and trailer equipped with tokens at each component to be inspected, illustrating a person using a portable device in accord with the present invention;

FIG. 2 is a top plan view of a portable device for use in making a safety inspection of a tractor and trailer, showing a message that prompts the operator to inspect the left rear tires of the tractor;

FIG. 3 is a schematic block diagram of the functional components included in the portable device of FIG. 2;

FIG. 4 is a top plan view of the portable device of FIG. 2, illustrating a menu that indicates possible conditions of tires in need of service;

FIG. 5 is a flow chart showing the steps followed in carrying out a safety inspection in accord with the present invention;

FIG. 6 is a flow chart illustrating the steps employed in recording a condition of a component that is being inspected using the portable device of FIGS. 2 and 4;

FIG. 7 (Prior Art) is an exemplary manually-completed inspection record used for safety inspections of tractors and trailers, illustrating the specific components and systems that are required to be inspected;

FIG. 8 is an exploded isometric view of a portion of a second embodiment of the portable device that includes a plurality of lights;

FIG. 9 is an isometric view of a front portion and lower surface of the second embodiment of FIG. 8;

FIG. 10 is an isometric view of the lower surface of a third embodiment of the portable device that includes a digital camera;

FIG. 11 is an isometric view of the upper surface of either the second or third embodiments;

FIG. 12 is a flow chart illustrating the steps implemented during a safety inspection in which the user has an option to record a digital image of a component being inspected;

FIG. 13 is a side elevational view of a bus, illustrating the disposition of a token adjacent to a rear of the bus that is scanned to ensure that a driver of the bus has inspected all of the seats to determine whether all passengers have been unloaded from the bus;

FIG. 14 is an isometric view of a docking station for the portable device;

FIG. 15 is an isometric view of the second or third embodiment seated within the docking station for data transfer;

FIG. 16 is a schematic diagram of the system for transferring data over the Internet, between the portable device in the docking station and storage on a remote server;

FIG. 17 is a schematic block diagram of the functional components included in an engine hour metering device in accord with the present invention;

and of the components that the metering device is adapted to be coupled to in a driver-operated, construction machine vehicle;

FIG. 18 is a schematic block diagram of the functional components included in the data interface of the engine hour metering device in order to allow for multiple transmissions of data across the data interface;

FIG. 19 is a flow chart illustrating the steps employed in utilizing the embodiment of FIG. 17 to collect data corresponding to the operational status of the driver-operated, construction machine vehicle; and

FIG. 20 is a flow chart showing a sequence of logical steps implemented by the controller of the metering device of FIG. 17.

### DESCRIPTION OF THE PREFERRED EMBODIMENT

Utility of the Present Invention

The present invention is applicable in recording data resulting from a safety inspection of almost any type of equipment, apparatus, or system and is applicable to other types of inspections in which it is desirable to maintain a data record as evidence that the person making the inspection was actually physically present at a checkpoint or component requiring inspection. While the data accumulated with the present invention is not conclusively presumptive evidence that each component of a system was indeed carefully inspected, in most cases, if a person is required to visit a checkpoint or component, it is very likely that the person will actually inspect the component. By encouraging a person making an inspection to be physically close enough to a component to carry out an inspection, and by providing evidence of that fact in the data recorded, there is at least a justifiable presumption that the person actually did the inspection.

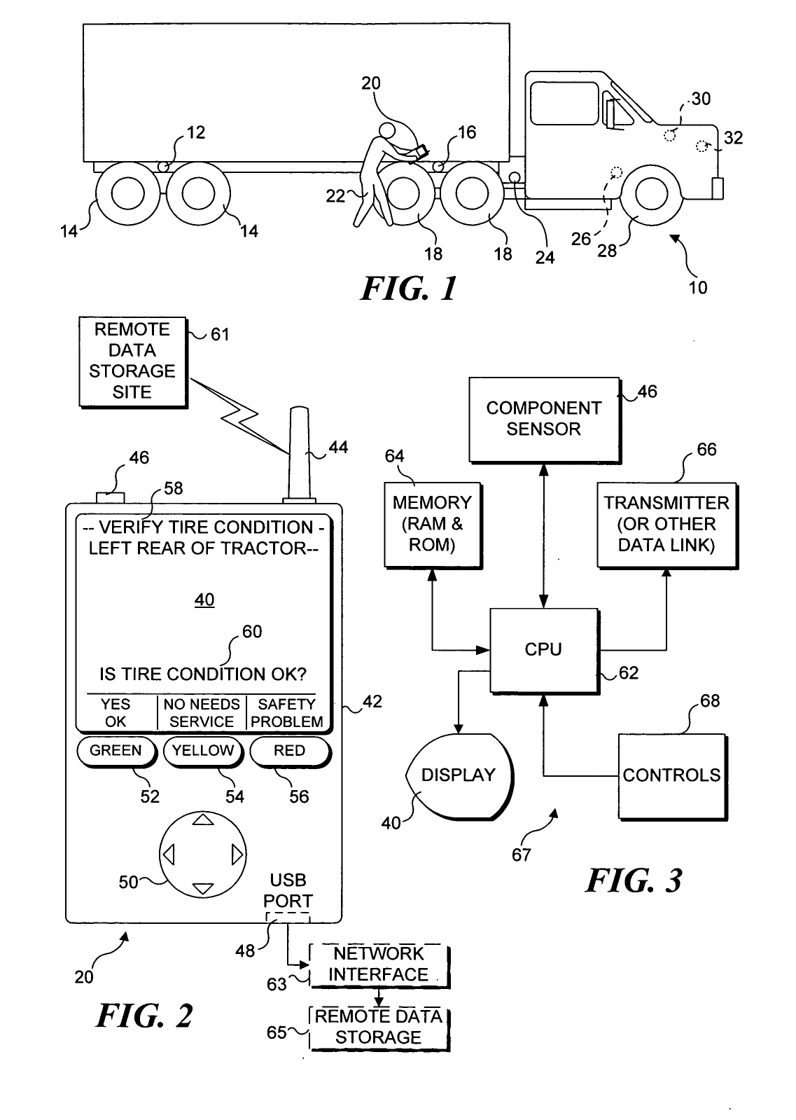

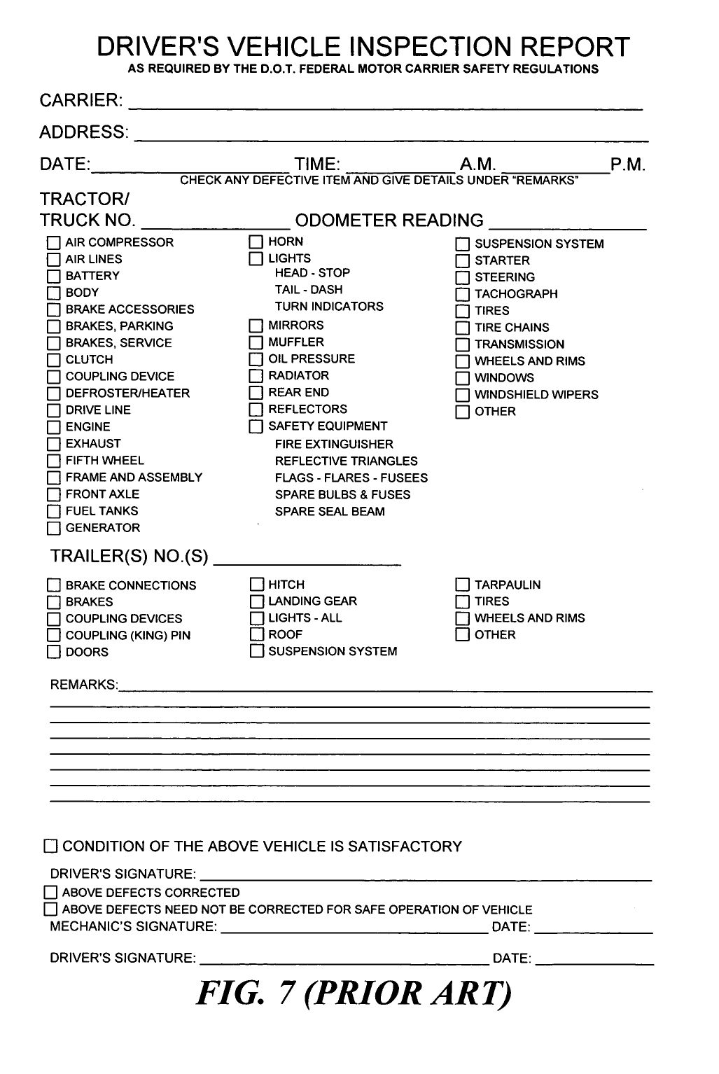

FIG. 1 illustrates a tractor-trailer 10 with which an embodiment of the present invention is usable to carry out a safety inspection. Tractor-trailer 10 is provided with a plurality of tokens affixed adjacent to each checkpoint or component that is to be inspected. While only a few of the tokens are illustrated in FIG. 1, FIG. 7 (Prior Art) lists all of the components or systems that should be inspected if a driver is to be in compliance with the DOT regulations regarding pre- and post-inspections of such vehicles. A token will preferably be affixed adjacent to the components and systems listed in FIG. 7, although several components might be associated with the same token. For example, in the engine compartment, one token might be used for both the radiator and the belts. As a driver moves about the tractor and trailer, evidence that the driver or the person doing the inspection moved sufficiently close to the components being inspected so that the inspection could actually take place is recorded in a portable device 20 (first embodiment). Further details of portable device 20 and of other related embodiments are described below.

For the few tokens illustrated in FIG. 1, the relevance of the disposition of the token adjacent to a corresponding component of the tractor-trailer 10 should be evident. For example, token 12 is disposed adjacent to tandem dual rear tires 14 on the trailer. Since all the tires of the tandem dual rear wheels on the left rear of the trailer are readily visible from a position adjacent to token 12, a single token is sufficient to determine that the driver was sufficiently close so that all four fires at the left rear of the trailer could be readily inspected. Similarly, tandem dual wheels 18 on the left rear of the tractor are readily inspected when an observer 22 is positioned as shown in FIG. 1. In this position, the observer moves portable device 20 within a maximum predefined range of token 16, which is exposed above tandem dual wheels 18. Portable device 20, detects and responds to token 16, recording data indicating that the driver was in a position to inspect tandem dual rear wheels 18 on the tractor. It is contemplated that the operator may initiate the recognition of a token by activating a switch, or the portable device can instead simply respond when a token is sufficiently close to the portable device.

Other tokens 24, 26, 30, and 32 are illustrated adjacent other components of the tractor that are part of the safety inspection. For example, token 26 is affixed adjacent a tire 28 on the right front of the tractor, while tokens 30 and 32 are accessible if the front hood of the tractor is opened and are disposed adjacent the hydraulic brake master cylinder and the engine belts/radiator, respectively (not shown separately).

For each token there is a predetermined maximum distance that portable device 20 can be held from the token that will enable the portable device to detect the token, and thus the component that is associated with it in order to produce a record as evidence that the person holding the portable device was in a position to inspect the component. Depending upon the component to be inspected and the type of token, different predetermined maximum distances may be assigned to the various components. The different predetermined maximum distances might be implemented by partially shielding a token to vary the distance at which the portable device can detect the token.

Operator 22 is prompted to approach the next component in a series of components that must be checked during the safety inspection by a message 58 appearing on a display 40 of portable device 20, as shown in FIG. 2. For example, if operator 22 has just completed the inspection of tandem dual tires 14 on the left rear of the truck, display 40 provides a prompt 58 indicating that the operator should “verify tire condition—left rear of tractor.” A sensor 46 on portable device 20 responds to token 16 when the portable device is held less than the predetermined maximum distance from token 16 by producing a signal indicating that the portable device was within the required range of tandem dual tires 18 to enable the operator to inspect the tires. Display 40 also provides a prompt 60 to operator 22 requesting that the operator indicate whether the tire condition is okay. If so, the operator presses a green control button 52 corresponding to the message “YES, OK.” However, in this first embodiment of the portable device, if during the visual inspection of the tires the operator determines that they require servicing, the operator is prompted to depress a yellow control button 54 on the portable device. (The other embodiments of the portable device that are described below do not include a yellow control button, but instead invite the operator to indicate the condition of the component.)

Certain conditions such as a tread separation or a nail or other sharp object lodged in the tire would likely lead the person doing the inspection to depress a red control button 56, indicating a safety problem that requires the operator to refer to a supervisor who will likely elect to delay the trip until the tire is repaired and/or replaced or take other appropriate action depending upon the nature of the component and the type of problem that makes the component unsafe to use. Portable device 20 also includes a cursor control 50, which is a four-position switch that enables a cursor (not shown in this Figure) to be moved up or down, and left or right. Cursor control 50, green, yellow, and red control buttons 52, 54, and 56 and display 40 are all disposed on a front surface of a housing 42 of portable device 20. Sensor 46 is disposed on the top edge of housing 42, while an optional universal serial bus (USB) port 48 is disposed on the bottom edge of housing 42, opposite from sensor 46.

In this embodiment, an antenna 44 is also disposed on the top edge of the housing for transmitting radio frequency (RF) transmissions to a remote data storage site 61 that is used for long-term storage of data resulting from safety inspections. The data produced by a safety inspection indicates each of the components of the vehicle (or other system or apparatus being inspected) that were visited by the operator, so that the portable device was positioned within the predetermined maximum distance from the token associated with the component, and further indicates the status of the component. In the event that the component appears to need service or represents a safety problem (as would be evident if the operator depressed yellow control button 54 or red control button 56, respectively), the operator is prompted to select one of a plurality of predefined conditions that justify the state of the component determined by the operator and best represent its observed condition.

If the state of the component is okay so that green control button 52 is depressed, i.e., if the component does not require any service and is usable or otherwise within its nominal operating parameters, there is no need to provide an indication of the condition of the component. The condition need only be recorded as part of the data stored in the portable device if either yellow control button 54 or red control button 56 is depressed by the operator to indicate the state of the component being other than “OK.”

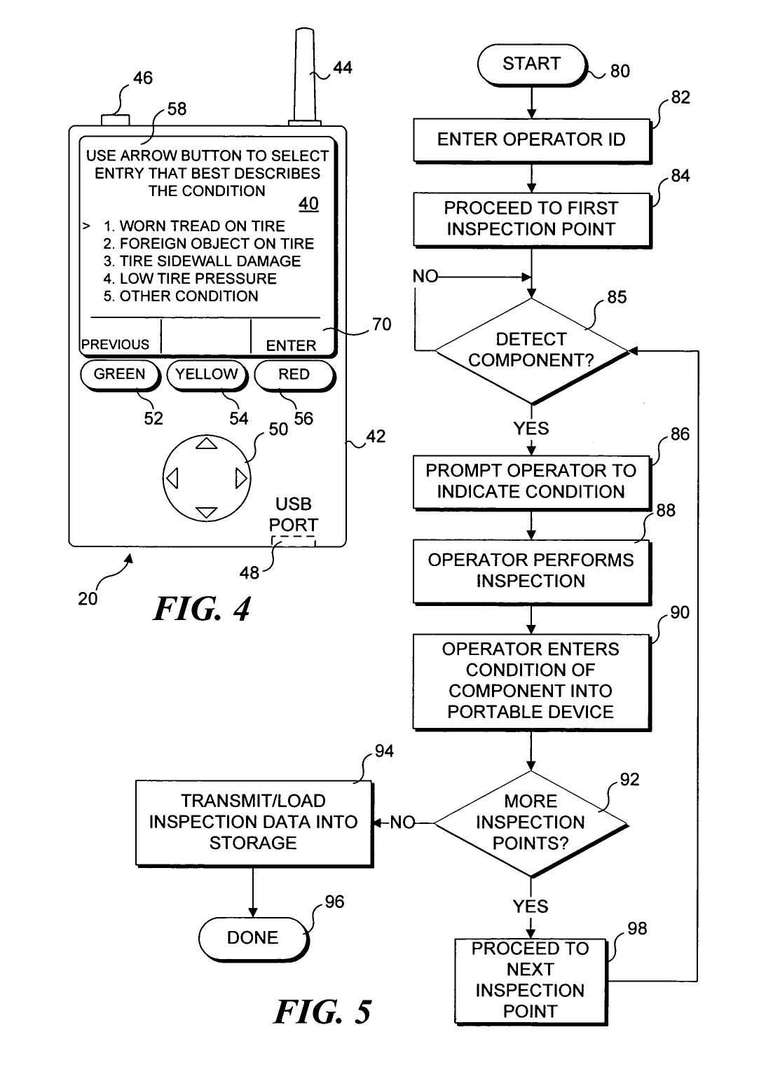

A further example illustrating the selection of a condition relating to the example shown in FIG. 2 is included in FIG. 4. As shown in FIG. 4, if the operator has indicated that the state of the tires is such that they need service by pressing yellow control button 54, portable device 20 automatically displays several possible conditions that would have led an operator to indicate that state. In the example shown, message 58 prompts the operator to use the arrow button (i.e., cursor control 50) to select a possible condition from among the listed options that best describes the observed condition of the tires. Display 40 includes five possible conditions, the last of which covers any condition that might not be included among the first four that are listed. Using cursor control 50, the operator can move the cursor to the displayed statement that best describes the observed condition of the tire and then can depress red control 56, which corresponds to an “Enter” menu option 70 on display 40 for this screen. Green control 52 can be depressed to select a “Previous” display, if the operator elects to reconsider the state of the component that was previously selected.

FIG. 3 illustrates functional components 61 that are included in portable device 20, either on or inside housing 42. A central processing unit (CPU) 62 comprises the controller for portable device 20 and is coupled bi-directionally to a memory 64 that includes both random access memory (RAM) and read only memory (ROM). Memory 64 is used for storing data in RAM and machine instructions in ROM that control the functionality of CPU 62 when executed by it. CPU 62 is also coupled to receive operator input from controls 68. Collectively, controls 68 include green control button 52, yellow control button 54, red control button 56, and cursor control 50. In addition, CPU 62 provides text and graphics to display 40 for the prompts and other messages, and menu items and options from which the operator can select using cursor control 50.

After operator 22 has visited each of the checkpoints required for the safety inspection, the operator can optionally transmit the data that have been collected during the inspection to remote data storage site 61 through an RF transmission via antenna 44. The data provide evidence that the operator has visited the components and indicated the state and condition of the components that were visited and inspected. Alternatively, optional USB port 48 on portable device 20 can be coupled to a network interface 63 on an external cradle or docking station (an example of which is described below in connection with other embodiments of the portable device), which is in communication with remote data storage 65, as shown in FIG. 2. In FIG. 3, CPU 62 is shown communicating data to transmitter 66 (or through another data link) using a wire and/or wireless data communication link. The data collected and stored in memory 64 of portable device 20 during the safety inspection can thus be safely transferred to the remote data storage site and retained for as long as the data might be needed.

In some cases, it may be preferable to transmit the data to the remote site immediately after making a safety inspection to ensure that the data retained in memory 64 are not lost should an accident occur that destroys portable device 20. An accident destroying the evidence that the safety inspection was implemented could have an adverse effect during any litigation related to the accident, which might allegedly have been caused by one of the components inspected. However, since the risk of such an accident is relatively remote, it is contemplated that an operator may collect the data from a number of safety inspections in memory 64 and then subsequently upload the data to remote data storage 65 by coupling the data to the external cradle or docking station that includes a USB port terminal and network interface to couple over the Internet or other network to a remote storage. The cradle or docking station might be maintained by a carrier at a freight terminal at least periodically visited by the truck that was inspected.

Alternatively, the external cradle or docking station might be disposed at a different site and/or connect to the remote data storage site through other types of communication links. One example of such a communication system is the OMNITRACS™ satellite mobile communication system sold by Qualcomm Corporation that enables drivers on the road and carriers to remain in communication with each other and enables the carrier to monitor the location of a tractor-trailer during a trip. By linking portable device 20 through USB port 48 to such a data communication system, the data stored within memory 64 can readily be transmitted to a remote site maintained by the carrier for long-term storage, even while a trip is in progress.

The tokens that are affixed at various points on the tractor-trailer (or adjacent components of other types of systems or apparatus unrelated to a vehicle) can be of several different types, depending upon the type of sensor 46 that is included on portable device 20. In a preferred form of the present invention, the token that is preferably employed is a radio frequency identification (RFID) tag that is attached with a fastener or an appropriate adhesive to a point on a frame or other support (not shown) adjacent to the component associated with the token. One type of RFID tag that is suitable for this purpose is the WORLDTAG™ token that is sold by Sokymat Corporation. This tag is excited by an RF transmission from portable device 20 via antenna 44. In response to the excitation energy received, the RFID tag modifies the RF energy that is received from antenna 44 in a manner that specifically identifies the component associated with the RFID tag, and the modified signal is detected by sensor 46.

An alternative type of token that can also be used in this invention is an IBUTTON™ computer chip, which is armored in a stainless steel housing and is readily affixed to a frame or other portion of the vehicle (or other type of apparatus or system), adjacent to the component associated with the IBUTTON chip. The IBUTTON chip is programmed with JAVA™ instructions to provide a recognition signal when interrogated by a signal received from a nearby transmitter, such as from antenna 44 on portable device 20. The signal produced by the IBUTTON chip is received by sensor 46, which determines the type of component associated with a token. This type of token is less desirable since it is more expensive, although the program instructions that it executes can provide greater functionality.

Yet another type of token that might be used is an optical bar code in which a sequence of lines of varying width encode light reflected from the bar code tag. The encoded reflected light is received by sensor 46, which is then read by an optical detector. Bar code technology is well understood in the art and readily adapted for identifying a particular type of component and location of the component on a vehicle or other system or apparatus. One drawback to the use of a bar code tag as a token is that the bar code can be covered with dirt or grime that must be cleaned before the sequence of bar code lines can be properly read. If the bar code is applied to a plasticized adhesive strip, it can readily be mounted to any surface and then easily cleaned with a rag or other appropriate material.

Yet another type of token usable in the present invention is a magnetic strip in which a varying magnetic flux encodes data identifying the particular component associated with the token. Such magnetic strips are often used in access cards that are read by readers mounted adjacent to doors or in an elevator that provides access to a building. However, in the present invention, the magnetic flux reader comprises sensor 46 on portable device 20. The data encoded on such a token are readily read as the portable device is brought into proximity of the varying magnetic flux encoded strip comprising the token.

As yet another alternative, an active token can be employed that conforms to the BLUETOOTH™ specification for short distance data transfer between computing devices using an RF signal. However, it is likely that the range of the signal transmitted by the token would need to be modified so that it is substantially less than that normally provided by a device conforming to the BLUETOOTH specification. It is important that the portable device be able to detect that it is proximate to the component only within a predetermined maximum range selected to ensure that the operator is positioned to actually carry out an inspection of the component.

Logical Steps Implemented in the Present Invention

FIG. 5 illustrates the logical steps implemented in connection with the present invention to carry out a safety inspection of a vehicle or other apparatus or system. From a start block 80, a step 82 provides for manual entry of an operator identification (ID) into a data record, or the operator ID can already be stored in memory of the portable device, or can be automatically entered in response to a special operator ID tag disposed on the vehicle. Cursor control 50 is employed to sequentially select digits from a displayed list, to input the operator ID for the individual making the safety inspection. The operator ID might be a four (or more) digit number or alphanumeric code. Alternatively, a plurality of possible operator IDs might be displayed as a list on portable device 20, enabling the operator to select his/her operator ID from the list using cursor control 50 and one of the three control buttons.

Once the operator ID is entered, portable device 20 prompts the operator to proceed to a first inspection point at a step 84.. For example, as indicated in FIG. 2, message 58 prompts the operator to verify the tire condition on the left rear of the tractor. A decision step 85 determines if the portable device has detected the token associated with the component that is next to be inspected. If not, the logic loops until the component is detected. Once sensor 46 on portable device 20 has detected the token associated with the current component to be inspected, the logic then advances to a, step 86 in which the operator is prompted to indicate a state of the component (and possibly, its condition). In a step 88, the operator performs the inspection, which may involve visually observing the state and condition of the component, or carrying out other steps that might be required to confirm the state and condition of the component. It is contemplated that in some types of inspections, a series of one or more steps might be required to test the component to determine if it is operating properly, needs maintenance or repair, or is unusable. Again, portable device 20 can be programmed to provide appropriate prompts to direct the operator through the series of steps required to carry out the inspection of such a component. Accordingly, in a step 90 the operator selectively enters the condition of the component into portable device 20 using the control buttons and cursor control 50.

A decision step 92 determines if there are further inspection points in the safety inspection currently being carried out. If not, a step 94 provides for transmitting or loading the inspection data into storage at a remote site; this step can be done immediately after the inspection is completed, or at some later time, perhaps after additional safety inspections have been completed, and/or after the portable device has been inserted into the external cradle or docking station. Once the data are transmitted to the remote site for long-term storage, the process is completed in a step 96.

Assuming that further inspection points remain in the safety inspection at decision step 92, a step 98 provides for the operator to proceed to the next inspection point, which will again be determined by a prompt displayed to the operator on display 40 of portable device 20. The logic then loops back to decision step 85, which determines if the sensor on the portable device has detected the component, indicating that the portable device is within the predefined maximum range of the token, thus ensuring that the operator is sufficiently close to the component to inspect it.

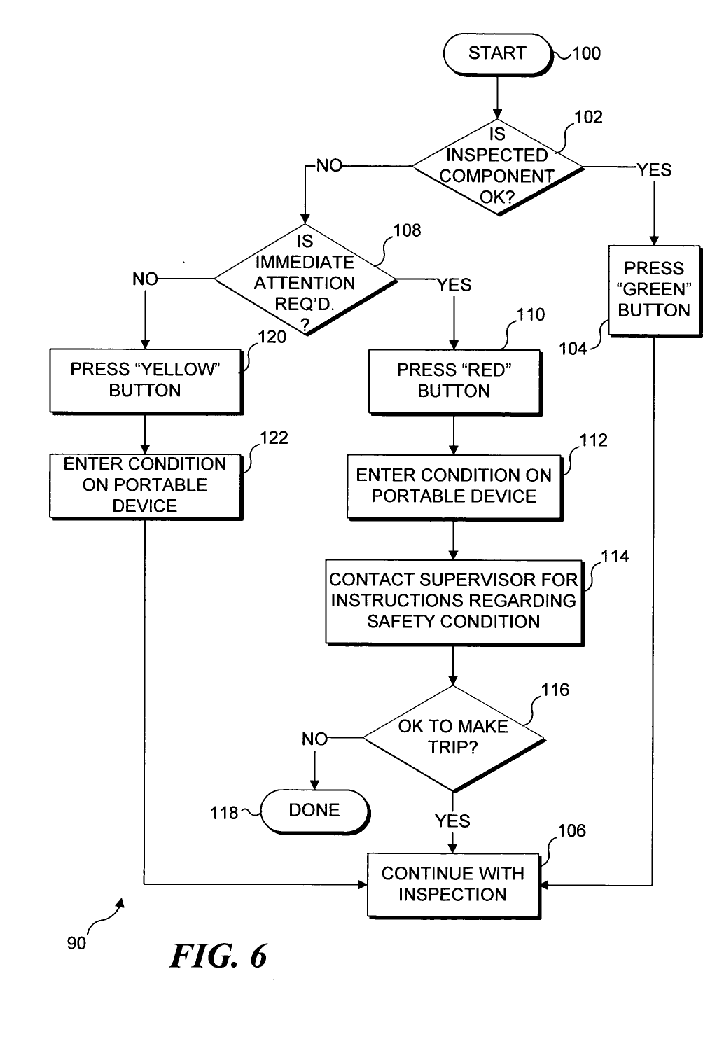

Further details of step 90 are illustrated in FIG. 6. From a start block 100, a decision step 102 determines if the inspected component is okay. If so, the operator presses green control button 52 in a step 104. Since the component is okay, nothing further is required for that component, and the logic then proceeds to a step 106, which provides that the operator can continue with the inspection, i.e., proceed with decision step 92 in FIG. 5.

However, if the determination in decision step 102 indicates that the inspected component is not okay, a decision step 108 enables the operator to determine if immediate attention is required. If so, the operator presses red control button 56 at a step 110 and enters the condition of the component on the handheld unit. For example, if the operator is inspecting a tire and determines that the tread of the tire is separating, i.e., that the tire should not be used but should instead be replaced, the operator would use the cursor control on the portable device to select an option for the condition “tread separating from tire” at a step 112. In many types of inspections, the operator will be required to contact a supervisor for instructions regarding the safety condition, at a step 114. In the example just noted, the supervisor would likely arrange for the tire to be replaced by maintenance or repair personnel before the operator makes a trip in the vehicle.

In some cases, a supervisor might override the operator's determination of the state of the component based upon the reported condition. Therefore, a decision step 116 determines if the supervisor has given authorization to the operator to make the trip, scheduling a later repair of the component. If so, the logic proceeds to step 106, in which the operator continues with the inspection as described above. If not, there is no further need to inspect the remainder of the vehicle at that point, since the complete inspection will need to be carried out again after the unsafe condition has been corrected, e.g., by replacing the defective tire. The logic is then done, as indicated in step 118.

In the event that the operator determines that immediate attention is not required at decision step 108, at a step 120, the operator presses yellow control button 54 on portable device 20. The operator then selects and enters the condition noted on the portable device, as indicated in a step 122. In the example shown in FIG. 4, six possible conditions are indicated by statements on display screen 40 for a tire that is still usable but needs service. In this case, the operator employs cursor control 50 to move the cursor to a selected statement that thus describes the observed condition of the component and then depresses red control button 56 to enter the condition, creating a record of the state and condition of the component currently being inspected that is retained within the memory of the portable device. Thereafter, the logic proceeds to step 106, in which the operator continues with the inspection.

Alternative Embodiments of Portable Device

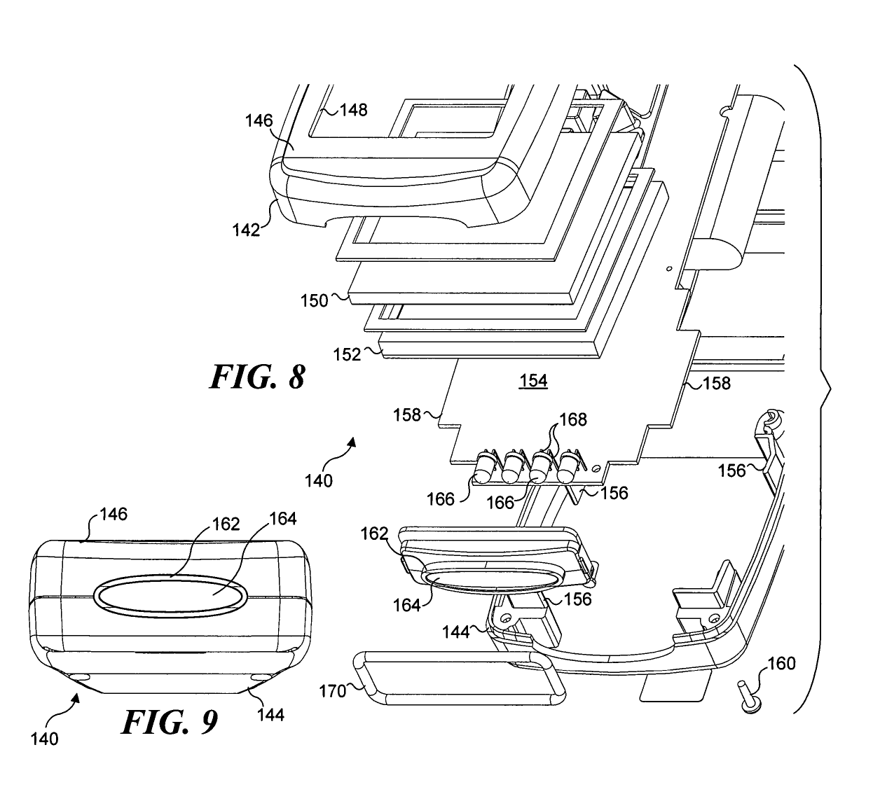

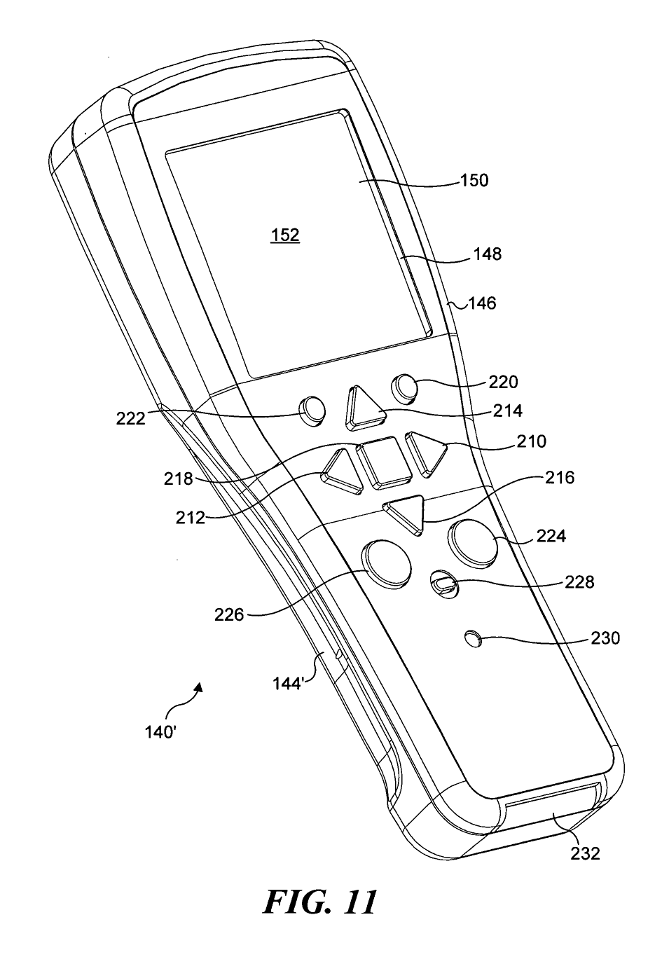

Two additional embodiments of the portable device are illustrated in FIGS. 8 and 9, and 10 and 11, respectively. A portable device 140, which is shown in FIGS. 8 and 9, has a top housing 142, which is joined to a bottom housing 144 and includes a display bezel opening 148. Only a portion of a top surface 146 of the top housing is illustrated in this Figure, although further details of the top surface are generally similar to the embodiment shown in FIG. 11, which is discussed below.

As clearly illustrated in the exploded view of FIG. 8, a substantially transparent protective plastic window 150 is mounted behind display bezel opening 148 to protect the upper surface of a liquid crystal display (LCD) 152. LCD 152 underlies the protective plastic window and is mounted on a printed circuit (PC) board 154, along with a number of other components (including CPU 62, memory 64, component sensor 46, and control 68, as shown and described above in connection with FIG. 3). A plurality of corner supports 156 engage side tabs 158 on PC board 154. In addition, a plurality of threaded fasteners 160 (only one of which is shown) extend between top housing 142 and bottom housing 144, to secure the two housings together, locking PC board in a position defined by corner supports 156 in cooperation with side tabs 158.

A front bezel 162 is seated at a front end of top housing 142 and bottom housing 144 and includes a lens 164 that is substantially transparent and serves to focus light emitted by a plurality of light emitting diodes (LEDs) 166, which emit white light. LEDs 166 are electrically coupled to PC board 154 by leads 168, which are soldered to appropriate electrically conductive trace connections (not shown) on the PC board 154. An elastomeric seal 170 is fitted around front bezel 162 to seal out dirt, moisture, and other contaminants from the interior of portable device 140. Since LEDs 166 are disposed immediately behind lens 164, the white light emitted by the LEDs is generally focused by lens 164 so that it can be directed by the operator of the portable device onto a component that is being inspected. Such components are sometimes disposed in areas that are not well illuminated by ambient light. Thus, the light from LEDs 166 better enables an operator to use portable device 140 to more clearly see a component that is being inspected and to better observe the condition of the component in order to determine its safety status. Including LEDs 166 on the portable device avoids the need to use a separate flashlight or other source of light to inspect components that are not well lighted by ambient light, or which must be inspected at night.

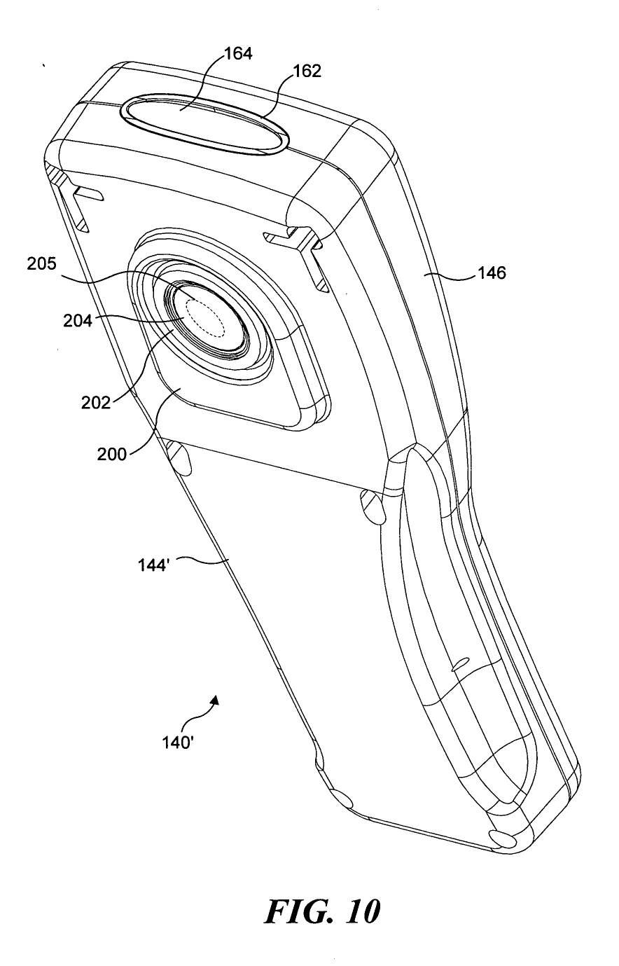

A portable device 140′ is illustrated in FIGS. 10 and 11, and like portable device 140, also includes a light source that can be selectively energized by an operator to illuminate a component that is being inspected, or for other purposes. However, portable device 140′ also includes a digital camera 200 that can be selectively activated by a user to record an image, e.g., an image of a component that is being inspected. Accordingly, if an operator makes a decision regarding the safety status of a component or makes a decision to replace a component, a digital image captured by digital camera 200 can provide evidence that justifies the decision made by the operator. Portable device 140′ is substantially identical to portable device 140 in most respects, except that it has a lower housing 144′ in which digital camera 200 is included. Digital camera 200 has a bezel 202 that supports a lens 204 for receiving light from a component that is being imaged by the digital camera. Not shown is a light sensitive element disposed inside the housing and mounted to an underside of the PC board. The light sensitive element, which may comprise an array of charge coupled devices (CCDs) or a complimentary metal-oxide semiconductor (CMOS), produces digital data corresponding to the light intensity at each pixel within a digital image that is being recorded. Although a higher quality might be achieved with a CCD light sensor, lower cost CMOS light sensors have recently become available that can also be used for the light sensitive device of the digital camera. Such devices are available from a number of different sources and can readily be integrated into portable device 140′.

For purposes of aiming and framing a desired image to be captured by digital camera 200, display 152 is switched to an imaging mode to display an image of the component. When framed as desired, the image shown on the display can be captured in real time, in association with the digital data corresponding to component being imaged and the image data can be stored within memory 64 (FIG. 3) of portable device 140′. It is not expected that an operator will need to record image data for each component being inspected, since only those components having a condition other than okay might need to be photographed with the digital camera, as evidence of the status of the component, should any question regarding the operator's decision subsequently arise. The image data produced by digital camera 200 will likely be stored in a compressed format, such as the Joint Photographic Experts Group (JPEG) format which employs a lossy compression scheme, as is commonly done with other digital cameras. The image data will thus be retained with the other data input by the user during an inspection and will be downloaded to long-term storage with the other data from the inspection.

FIG. 11 illustrates further details of top surface 146 of portable device 140′ (and 140). Controls included on the front surface include a Right cursor control button 210, a Left cursor control button 212, an Up cursor control button 214 and a Down cursor control button 216. Centered between these four control buttons is a Read/Enter control button 218, which is depressed when a user wants to enter a selection currently highlighted (selected) on display 152. Since both portable device 140 and portable device 140′ include the internal white LED light source, a light power switch 220 is included that can be momentarily depressed by a user to energize the LEDs, to illuminate a component that is being inspected, or to produce light for some other purpose of the operator. Adjacent to Up cursor control button 214 and opposite from light power switch 220 is an Info/Menu button 222 that can be depressed at any time to bring up a current menu on display 152. During the inspection, while viewing the condition of each component being inspected, the user will have an option and will be prompted to press either a green control button 224, which is also pressed to indicate a Yes condition, or a red control button 226, which is also pressed to indicate a No condition.

Neither the second or third embodiments of the portable device include a yellow button. Instead, if the condition of the component is not okay, the operator is simply prompted to select one of several predefined conditions that represent the status of the component being inspected, which can range from a condition in which the component may still be usable, to a condition that justifies immediate repair/replacement of the component. These conditions are presented to the operator on display 152. Using the cursor control buttons, the operator selects the appropriate entry of the condition on the display and depresses Read/Enter control button 218. Furthermore, if the condition of a component is not okay, the operator will be prompted to record a digital image of the component. If the operator presses green button 224 in response to this prompt, display 152 will then switch to the image display mode to show the image that might be captured by digital camera 200. Once the operator has directed lens 204 of the digital camera and positioned the portable device so as to frame the component as desired, as indicated by the image on display 152, the operator depresses Read/Enter control button 218 to capture the image of the component, storing the corresponding image data produced by the digital camera within the memory of the portable device.

A power On/Off switch 228 is disposed between green control button 224 and red control button 226 and slightly offset therefrom. Below the power On/Off switch is a charge indicator 230, for indicating the charge condition of the internal battery supply (not shown) that is contained within the housing of the portable device. A power/data connector port 232 is disposed on an end of the portable device for connecting to an external cradle or docking station, which is discussed in greater detail below. Neither portable device 140 nor portable device 140′ include an external stub antenna, as in the first embodiment. Instead, an antenna (not shown) is included internally within the upper and lower housings of the portable device. Use of an internal antenna is preferred, since it avoids potential breakage of an external antenna. It has been determined that an external antenna is not required for sensing RFID tokens. However, like the first embodiment of the portable device described above, portable devices 140 and 140′ are used to sense when the portable device is within sufficient range of a token to ensure that the operator is then positioned to inspect a component, to determine the safety status of the component, or to evaluate some other parameter of the component. The other types of tokens and sensors discussed above in connection with the first embodiment of the portable device are also contemplated for use with either the second or third embodiments of the portable device. Accordingly, those options need not be further discussed in regard to portable devices 140 or 140′.

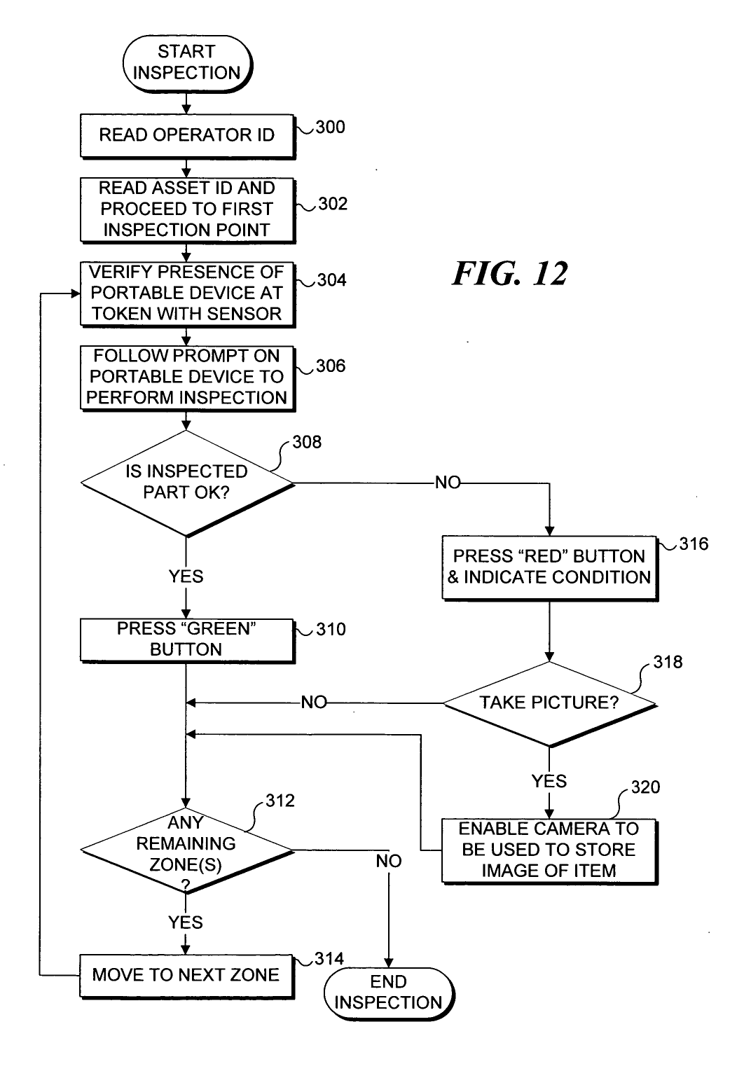

FIG. 12 illustrates the steps involved in using either portable device 140 or 140′ in connection with carrying out an inspection on a vehicle or other type of apparatus or processing facility. Carrying the portable device, an operator starts the inspection, and as indicated in a step 300 uses the portable device to read an operator ID, to input data identifying the operator who is currently using the portable device. This ID can be read from a token associated with the operator, for example, a token that is carried by the operator on a keychain or as a part of a photo identification card. The operator ID is then recorded as part of the data associated with the current inspection and stored in the memory of the portable device for later transmittal and storage at a remote site.

A step 302 then provides that the operator reads an asset ID for the vehicle or apparatus or processing equipment being inspected, which is also stored within the data associated with the current inspection and is provided by a token, which is attached to the asset. Alternatively, the operator might manually enter an asset ID before undertaking the inspection. Having input the asset ID, the operator proceeds to the first inspection point.

In a step 304, the presence of the portable device (and of the operator) is verified at a token fixed adjacent to the first inspection point. The portable device automatically senses the token and stores data providing proof that the operator had physically carried the portable device to the inspection point associated with the token. Next, a step 306 indicates that a prompt to the operator is displayed on the portable device, indicating the next steps of the inspection to the operator. As noted above, a series of inspection steps may be required to complete an inspection of a specific component, or the operator may be prompted to inspect several components that are all associated with the current token. Following step 306, in a decision step 308, the operator determines if the inspected part is okay. If so, the operator presses the green control button on the portable device as indicated in a step 310. A decision step 312 then determines if there are any remaining zones or points to be inspected during the current inspection and if so, a step 314 provides that the operator moves to the next zone or point where one or more components are disposed that require inspection. The logic then returns to step 304. Alternatively, if there are no remaining zones, the operator has concluded the inspection.

Returning to decision step 308, in the event that the inspected part or component is not okay, the operator would press the red control button at a step 316 and as prompted on the display, would enter or select a condition of the component that led the operator to conclude that its condition was not okay. Display 152 on the portable device would then prompt the operator to decide whether to take a picture, at a decision step 318, of the component (this option only applies to portable device 140′). If the operator decides to take a picture of the component, a step 320 enables digital camera 200 to be used to create image data for the item. As described above, display 152 shows the image that is to be recorded in real time, enabling the operator to frame the picture by positioning the portable device relative to the component so that the desired image of the component appears on the display. The operator then presses the Read/Enable control button, capturing the image as it thus appears on display 152, so that the image data are recorded within the memory of the portable device. Thereafter, the logic continues with decision step 312. If the user is employing portable device 140 rather than portable device 140′, following step 316, the logic would proceed directly to decision step 312, since there would be no option for taking a picture.

Docking Station

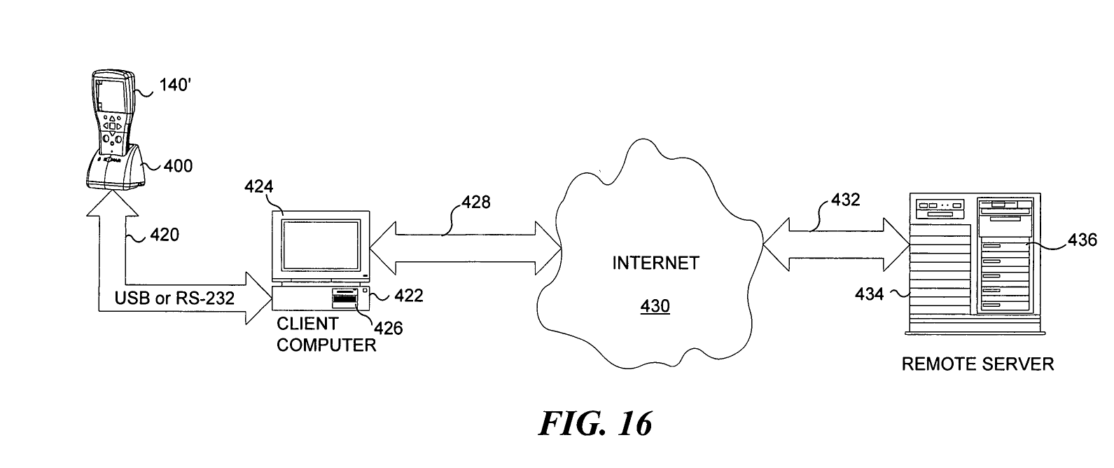

FIGS. 14 and 15 illustrate a docking station 400 for the portable device of the present invention. Docking station 400 includes a housing 402 having a receptacle 404 into which either portable device 140 or 140′ can be fitted. FIG. 15 illustrates portable device 140′ inserted within receptacle 404 to facilitate downloading of the data stored within the portable device to a remote storage. The docking station 400 includes an indicator light 406 that changes color to indicate that data are being transmitted from portable device 140 or 140′ to another device. Docking station 400 includes an interface circuit that couples the data port on portable device 140 or 140′ to a personal computer 422 through a lead 420, as shown in FIG. 16. The interface circuit converts the data format of portable device 140 and 140′ to a universal serial bus (USB) or serial RS-232 format for communication with personal computer 422. Accordingly, data link 420 is connected either to the USB port or serial port on personal computer 422 from a port 408 on docking station 400 (see FIGS. 14 and 15). It is also contemplated that other types of computing devices might be used instead of portable computer 422, and other types of data format can be employed. As shown, portable computer 422 has a display monitor 424 and a hard drive 426 for recording data temporarily transferred from portable device 140 and 140′ . Subsequently, the data stored on hard drive 426 are downloaded through a data link 428, over Internet 430, and through a data link 432 to a remote server 434, which includes additional storage in the form of a plurality of hard drives 436. It is contemplated that docking station 400 might be disposed in a terminal or other location to which the portable device is returned between inspections or at other times, to transfer data from the memory within the portable device to remote storage on remote server 434.

Data links 428 and 432 can each comprise a telephone modem connection over a telephone network, a wireless data link, a broadband connection through a DSL interface or cable modem, or a cell phone link. Alternatively, personal computer 422 can be directly connected over a local area or wide area network to remote server 434. In general, it is only necessary that the data stored within portable device 140 or 140′ resulting from one or more inspections be transferred to a more permanent storage, whether in personal computer 422 or in remote server 434, so that the memory within the portable device is thereafter available to store data from further inspections. By providing remote storage of the data that is downloaded from the portable device from time to time, the security and maintenance of the data are ensured.

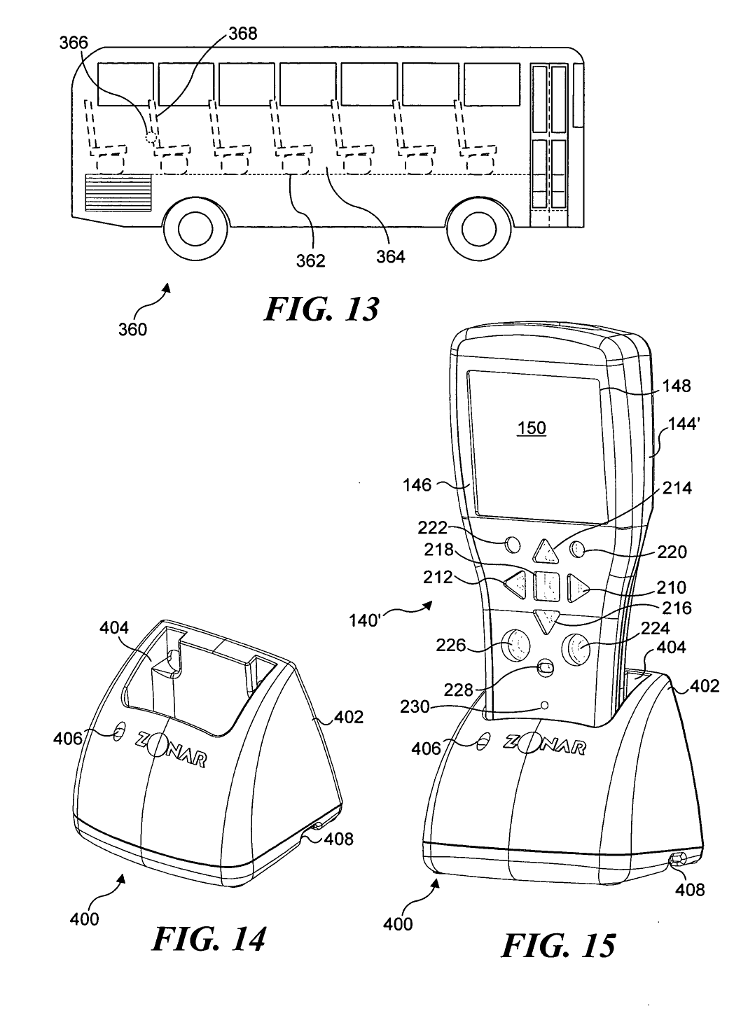

FIG. 13 illustrates another aspect of the present invention. For purposes of carrying out safety inspections of a bus 360, which may be a school bus, a last safety check made by the operator (e.g., the driver) might be a check to ensure that all of the passengers have exited from the bus. As shown in FIG. 13, bus 360 includes a plurality of seats 362 at spaced-apart intervals along an aisle 364. To ensure that a child has not fallen asleep or hidden below or behind the seats, at the end of the route, the driver should make a thorough visual inspection of all of the seats in bus 360, which can only be done by walking to the rear of the bus. Accordingly, a token 366 is attached to the back of a seat 368 disposed adjacent to the rear of the bus. By bringing the portable device in proximity with token 366, the operator can thereby confirm that the rear of the bus was visited at the end of a route to ensure that the driver at least had the opportunity to visually confirm that no passengers remained on the bus. Without making such an inspection, it is possible that child might remain on a bus when it is returned to a facility for storage, which at the very least, would cause considerable concern to the parents of the child. Thus, the present invention helps to ensure that the driver is motivated to make an inspection to ensure that no child remains on the bus at the end of a route.

Other Type of Portable Device

While it is likely that an initial preferred embodiment will employ portable device 20, 140, or 140′, it is also contemplated that an accessory might be provided for a personal digital assistant (PDA), such as the PALM™ PDA, that would enable the PDA to be used for the same functions as the portable devices discussed above. The accessory to the PDA would include a sensor to detect when the PDA is within the predetermined maximum range from the token associated with the component currently being inspected. The conventional controls on the PDA can be used to make and enter a selection. Furthermore, instead of using a cursor control, it is also contemplated that a touch screen display might instead be used for making selections of menu items and other options presented to the operator. In addition, the PDA would need to be programmed to carry out the functions implemented by the portable devices described above.

Other Applications of the Present Invention

Although the present invention will initially be used in connection with safety inspections of tractors and trailers in the commercial trucking industry, there are many other types of safety inspections unrelated to vehicles in which it is equally applicable. Other types of vehicles besides trucks, such as aircraft and buses, can also benefit from use of the present invention to provide proof that the components of the vehicle have been visited and observed by the operator or other person doing an inspection. Still other applications of the invention are not related to vehicles. For example, in a chemical processing plant or a petroleum refinery it is common for technicians to make periodic safety inspections of valves, gauges, reactors, pressure vessels, and other types of processing equipment and system components to ensure that they are operating properly and within nominal or acceptable limits. During an inspection, a technician may note that a valve is leaking slightly, and schedule it for repair or replacement at a later date. Clearly, if the leak is of a non-hazardous substance and is insignificant in volume, there might well be no reason to shut down the process line in which the valve is installed simply because of the leaking valve. However, if the valve controls an extremely hazardous or toxic substance, even a small leak may be unacceptable. In this case, the technician should immediately report the leaking condition of a valve to a supervisor who would then likely shut down the process or divert the flow of hazardous substance to a different process line to enable the condition to be corrected by immediate replacement or repair of the valve. Additional applications, without any implied limitation, include the inspection of amusement park rides, such as roller coasters, etc., where the condition of many different components of the ride can directly impact on its safety.

While the preceding discussion discloses how a first preferred embodiment of the present invention is used in recording data related to safety inspections of a vehicle, it should be evident that portable device 20, 140 or 140′ is readily adapted to recording data from virtually any type of inspection. In the example of a non-vehicular inspection in a chemical processing plant just noted, a technician would be prompted by the portable device to inspect the valve, and once the portable device was within a predetermined distance of the valve, would be prompted to indicate a state of the valve. If the technician depressed either yellow control button 54 or red control button 56 (on portable device 20), or red button 226 (on portable device 140 or 140′ ), the display would provide a menu of possible conditions from which the technician could select, using the cursor control to select and indicate the observed condition of the valve. Also, other conditions that are not directly related to safety can be recorded with the present invention.

Extraction of Engine Hour Data from a Modified Token using a Portable Reader

Another embodiment of the present invention relates to extracting data stored in a token using a portable reader generally consistent with those described above (i.e. portable device 20, 140 or 140′ ). A particularly preferred implementation of extracting data stored in a token (or in a memory associated with a token) relates to extracting engine hour data from fleet vehicles (such as buses and trucks) or driver-operated construction equipment (such as excavators, bulldozers, forklifts, backhoes, cranes, and graders). In the following discussion, where the term vehicle is used, it should be understood that the metering device of the present invention can also be implemented in various types of equipment including a prime mover, where it would be desirable to obtain engine hour data from the prime mover. The collection of engine hour data is important for a number of reasons. Particularly for heavy-duty vehicles and construction equipment, maintenance schedules are often prepared based on the number of hours and engine has been operated, as opposed to the number of miles of vehicle has been driven. Furthermore, particularly with respect to construction equipment, because such equipment can be very expensive to purchase, such equipment is often leased or rented to construction firms for a period of time. Such rental contracts are often based not only on the length of the contract rental period (i.e. the number of days the equipment is rented or leased), but also on the total number of engine hours utilized.

The following example illustrates a rental contract based both on a specific contract period and the number of engine hours utilized. Consider a seven day rental period for a bulldozer. Assume that the bulldozer's engine is started at 6 AM each morning of the rental period, and the engine is operated until 12 noon. The operator takes a thirty minute lunch break, during which the bulldozer's engine is off. After lunch, the bulldozer's engine is restarted at 12:30 PM and operated until 7 PM. Further assume that this pattern is repeated for all seven days of the rental period. If the bulldozer is equipped with a metering device configured to collect engine hour data, the rental company is able to base the rental charges not only on the seven-day rental period, but also on the eighty-seven and one-half hours engine hours that were utilized during the seven day rental period. This enables a rental company to charge customers who operate the bulldozer more often during the seven-day rental period a higher fee, which is reasonable because such customers consume more of the bulldozer operational life. Furthermore, the engine hour data can be used by the rental company to ensure that maintenance schedules are based on how long the engine of the bulldozer has been used, as opposed to how long the bulldozer has been in service. Furthermore, if the bulldozer includes an idle time sensor, and the idle time sensor is coupled to the metering device configured to collect the engine hour data, then the metering device can provide not only total engine hour data, but also to include data corresponding to how long the engine of the bulldozer was running, without the bulldozer actually being used. Such data may be desired by the renters of the bulldozer, because such data can be used to evaluate the efficiency of the work crew using the bulldozer during the rental period. Idle time data is also often desired by environmental regulatory agencies, because equipment and vehicles that are idle generate pollution without also producing any economically valuable work. Reducing idle time can reduce pollution without any negative economic effects (indeed reducing idle time will often result in an economic benefit, because the fuel used it to run idle engines will be saved when idle time is reduced).

It should be understood that the extraction of engine hour data (or other data) using a portable reader encompasses using a portable reader to extract data from a modified token (a token including a memory or coupled with a memory), the present invention also encompasses extracting engine hour data from a sensor using a portable reader, regardless of whether the sensor is considered a token. While in a particularly preferred implementation the portable reader will extract the data from the sensor/token without requiring a physical connection between the sensor/token in the portable reader, the present invention also encompasses embodiments in which a physical connection must be made between the portable reader and the sensor/token in order to extract data from the sensor/token. The IBUTTON™ computer chip discussed above represents an exemplary data interface that requires a physical connection with a portable reader to extract data. Of course, conventional data ports including serial ports, parallel ports, and USB ports can be used to implement a data interface requiring a physical connection with a portable reader, such that a portable reader can extract data from a sensor/token. It should thus be understood that the present invention further encompasses a modified token or sensor configured to 1) collect engine hour data; 2) store engine hour data; and 3) enable the stored engine hour data to be extracted using a portable reader.

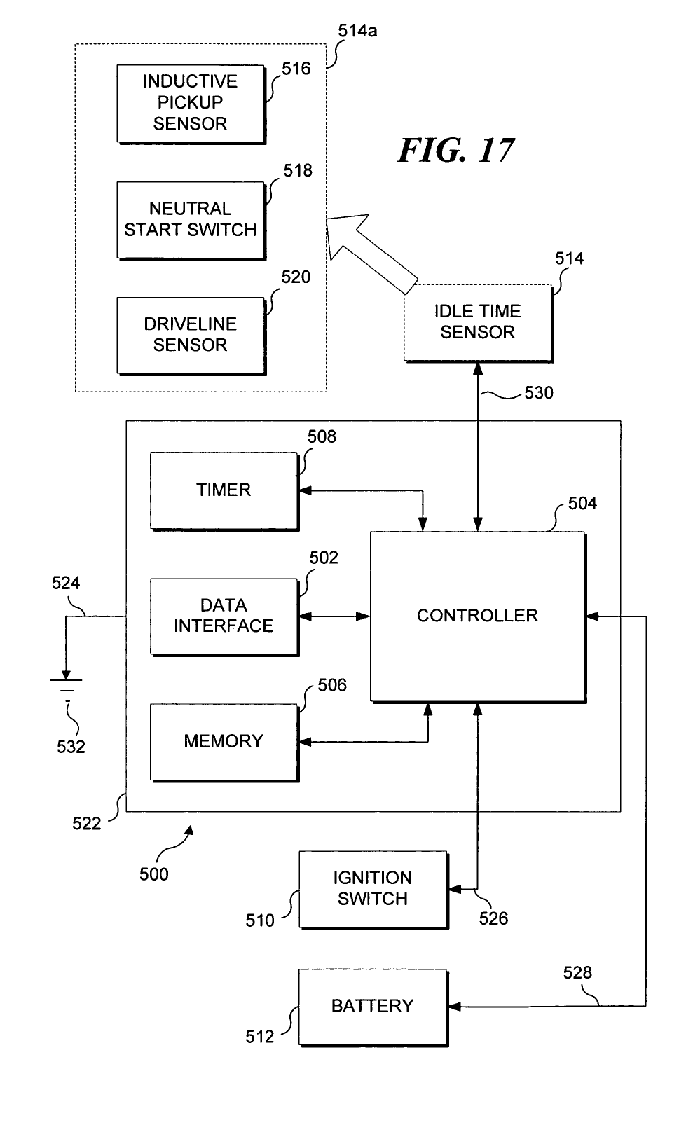

FIGS. 17-20 relate to the collection and extraction of engine hour data in accord with the present invention. Essentially, a metering device is coupled to an ignition switch in a vehicle or piece of heavy equipment. The metering device includes a controller logically coupled to timer that keeps accurate track of elapsed time whenever the ignition switch is in a “switched power” position. Those of ordinary skill in the art will recognize that the switched power position corresponds to the position of an ignition switch which must be selected in order to selectively energize a prime mover, such as a diesel engine. While engine hour meters are most often used in connection with diesel engines, it should be understood that the metering device of the present invention is not limited for use with only diesel engines, but with any type of engine selectively energizable using control unit such as an ignition switch. For vehicles and equipment equipped with an ignition switch that is actuated using a key, it is often possible to move the key to the switched power position without actually engaging a starter mechanism required to start the engine. Because the metering device of the present invention keeps track of how long the ignition switch is in a switched power position, and because it is technically possible for the ignition switch to be in the switched power position without the engine being operational (because the starter was not engaged or because the engine failed to start), it should be understood that the engine hour data collected by the metering device of the present invention can include erroneous data. It would be theoretically possible to couple a metering device to the engine itself; for example, the metering device could be coupled to an alternator associated with the engine, such that engine hour data is only generated when an alternator or generator operated by the engine is producing electricity to recharge battery used for starting the engine. However, the wiring required to couple a metering device to a vehicle's electrical system as opposed to a vehicle's ignition system is sufficiently complex that most operators of fleet vehicles and construction equipment would prefer a simpler to install system that includes a margin of error over a more complex system having a smaller margin of error. The metering device further includes a memory in which engine hour data are stored, and a data interface enabling the data to be extracted. In addition to being coupled to the ignition switch, the metering device of the present invention is also coupled to a battery associated with the engine (i.e. the battery coupled to the ignition switch and used to start the engine), so that the metering device can be powered up to enable data to be transferred to a portable reader without requiring that the engine be operational. This represents a significant advantage, because the engine hour data can be extracted from the metering device without requiring any manipulation of the ignition switch. Depending upon where the data interface is positioned, the portable reader can access the data without requiring an operator to have access to the ignition switch, or even the cab of the vehicle/piece of equipment. For example, if the data interface is positioned outside of a locked cab, then an operator can use a portable reader to extract data from the data interface without having to unlock the cab to gain access to the interior of the cab or the ignition switch of the vehicle/piece of equipment.

FIG. 17 schematically illustrates the functional components included in an exemplary engine hour metering device 500, which can be beneficially incorporated into a vehicle or a piece of heavy equipment that includes a prime mover, such as a diesel engine, to enable the engine hours to be recorded and extracted using a handheld device, without requiring that the prime mover be energized, or even requiring that the ignition system be switched to a “power on” or an “accessory” position. Metering device 500 includes a data interface 502, a controller 504, a memory 506 (preferably nonvolatile), and a timer 508. Preferably, a housing 522 encloses data interface 502, controller 504, memory 506, and timer 508, although, if the metering device is placed in a protected location (such as within the cab of a vehicle), the housing is optional and not required. In a particularly preferred implementation, housing 522 is waterproof and shock resistant, so that metering device 500 can be secured to the exterior of a vehicle or piece of construction equipment that includes a prime mover, without requiring access to secured portions of the vehicle/equipment in order to interact with the data interface using a portable reader.

In one preferred implementation, metering device 500 is installed in a vehicle or a piece of equipment having a prime mover using three wires, including a wire 526 that couples the controller to an ignition switch 510, a wire 528 that is coupled to a battery associated with the vehicle/equipment (generally this will be a battery used to start the engine, although a dedicated battery can be implemented if desired), and a wire 524, which is coupled to a ground 532. If a dedicated battery is employed for the metering device (instead of coupling the metering device to the vehicle's battery), then the dedicated battery can be included in housing 522.

As described in greater detail below, coupling the metering device to the battery already provided in the vehicle/piece of equipment enables metering device 500 to collect additional useful information related to the condition of the battery. If the vehicle/piece of equipment is equipped with an optional idle time sensor 514, a wire 530 is used to couple the idle time sensor to the metering device. As noted above, idle time data can be used to determine how efficiently a piece of equipment is being used and is therefore one type of data that is frequently requested by environmental regulatory agencies.

A plurality of different common idle time sensors are indicated in a block 514a, including an inductive pickup sensor 516, a neutral start switch 518, and a driveline sensor 520. Inductive pickup sensors are generally responsive to engine RPMs, with RPMs below a predefined value generally indicating that the engine is at idle. Neutral start switch sensors can be used to detect whether a transmission has been engaged, where a transmission placed in neutral generally indicates that no useful work is being performed by a vehicle or a piece of equipment. Driveline sensors are used to detect the rotation of a driveline, and the absence of rotation indicates that while the engine may be running, no useful work is being performed. It should be understood that any of these types of idle time sensors can be employed, and further, that these types of idle time sensors are intended to be exemplary, rather than limiting on the scope of the present invention.

Controller 504 is central to the metering device. The controller communicates bi-directionally with data interface 502, memory 506, and timer 508. In addition, the controller is also logically coupled to ignition switch 510 and may be logically coupled to idle time sensor 514, in vehicles/equipment equipped with idle time sensors. Preferably, the controller is implemented as a microprocessor, such as a central processing unit that executes a software program comprising machine instructions stored in the memory. Alternatively, the controller may be implemented using an application specific integrated circuit (ASIC). In either case, the controller is configured to execute a plurality of functions. Those functions, at a minimum, will typically include using a timer to generate engine hour data whenever the ignition switch is in a position indicating that the prime mover of the vehicle/equipment is operating (for most ignition switches, this position is referred to as a “switched power position” or a “power on position”), storing the engine hour data in the memory, and responding to a request for data from an external reader by accessing the memory and using the data interface to export the data to the reader.

Preferably, the engine hour data are stored with a resolution of about six minutes (i.e., the engine hour data are stored in six minute or 0.1 hour increments), which can be achieved by configuring the controller to update the engine hour data in the memory every six minutes when the ignition switch is in the switched power position. Significantly, because the metering device is coupled to the battery in the vehicle/equipment (or to a separate battery power source), data can be extracted from the metering device without requiring the engine to be started, or without requiring that the ignition switch to be placed in an accessory position, to energize the metering device. Thus, data can be extracted even when the vehicle/equipment is secured, and an ignition key for the vehicle/equipment is not available (so long as the data interface is accessible).

In certain embodiments, the controller may be configured to implement additional functions. For example, for vehicle/equipment equipped with an idle time sensor, the controller can be configured to respond to input from the idle time sensor by using the timer to generate idle time data, and storing the idle time data in the memory. Upon receiving a request for data from an external reader, the controller transmits both the engine hour data and the idle time data to the external reader, using the data interface.

A particularly useful additional functionality involves collecting and exporting data indicating the condition of the battery in the vehicle/equipment, which is relatively easy to provide, since the metering device is preferably coupled to the battery already present in the vehicle/equipment to facilitate starting the engine. In at least one preferred embodiment of the metering device, the controller is configured to periodically determine the battery voltage when the ignition switch is in the off position. In a working prototype of the present invention, the controller was configured to sample battery voltage every 30 minutes.

By collecting battery voltage data periodically while the vehicle/equipment is not in use, the condition of the battery and/or electrical system can be evaluated. If there is an electrical short in the electrical system of the vehicle/equipment, the battery will slowly discharge when the vehicle/equipment is not in use, thereby gradually reducing the voltage level of the battery over time. The battery voltage data collected by the metering device will thus provide an indication of such a short circuit condition, so that maintenance personnel can be informed of the potential problem. Appropriate action to correct the problem can then be taken by maintenance personnel before the condition worsens, and before the vehicle/equipment becoming inoperable. While batteries will naturally discharge over time, the discharge rate of a healthy battery that is not subjected to an internal short or a short in the equipment to which it is connected is significantly different than the discharge rate of the battery nearing the end of its useful life.

For example, nominal 12-volt batteries are often used in vehicles. While the engine is operating and the battery is being charged, it is not unusual for the voltage across the battery terminals to be about 13.8 volts. If the voltage of the battery is measured immediately after shutdown, the voltage will likely drop to a value of about 12.8 volts. If the vehicle is not operated for several days, and the voltage of the battery drops to below about 11 volts, it is likely that there is a short present internally in the battery or in the electrical system of the vehicle/equipment, or that the battery itself is nearing the end of its useful life. Where the size of the memory in the metering devices is limited, the controller can be configured to store the lowest-measured voltage of the battery, instead of storing all of battery voltage levels sampled.

Timer 508 is configured to provide a timing signal to the controller to enable the metering device to keep track of time. The temporal data collected and stored by the metering device can include only engine hour data, or both engine hour data and idle time data. Many different types of timers can be implemented. A functional and simple timer module can be implemented using a quartz crystal-based component. Many different types of commercially available integrated circuits include both a timer element and a microprocessor (enabling a single commercially available component to be used to implement the timer and controller). More complicated timers use a receiver configured to obtain a timing signal from a remote source, such as a GPS satellite signal, or the national atomic clock standard WWVB radio signal transmitted from Boulder, Colorado.

Where the controller includes a microprocessor, memory 506 can be used to store machine instructions for enabling the microprocessor to implement the plurality of functions described above, as well as for storing the engine hour data (and idle time data and/or battery voltage data, as described above).

Data interface 502 enables data to be extracted from the metering device. In a preferred embodiment, the data interface is implemented as an RFID tag, enabling data to be extracted without requiring a physical connection between the data interface and the portable reader. Metering devices that implement data interface 502 using an RFID tag can be read using any of portable devices 20, 140, or 140′ . Because conventionally available RFID tags generally have a limited baud rate, metering devices incorporating RFID tags as data interfaces can be configured to provide a plurality of outputs based on a single request for data. For example, a standard RFID tag hold ten 4-bit nibbles of data. These data are encoded with row and column parity. In order to send more data across the RFID link, a protocol can be provided that enables multiple transmissions of RFID data over the RFID data link (preferably, a 125 kHz link). An exemplary protocol will separate the data to be transmitted into a plurality of subsets. During an initial read, the RFID data link identifies the number of additional reads that will be transmitted, based on a single request for data. Subsequent reads will transmit subsets of the data collected. For example, if the data to be transmitted includes engine hour data, idle time data, and battery voltage data, each of those different types of data can be considered a subset, to be transmitted as a separate read. If more than one subset of data can be transmitted in a single read, then fewer reads than there are subsets can be employed.

While it is preferable to implement data interface 502 using an RFID tag, it should be understood that the present invention is not thus limited. The IBUTTON™ computer chip discussed above could also be used to implement the data interface (i.e., the IBUTTON™ computer chip might be used to simultaneously implement the controller, the memory, and the data interface). Furthermore, it should be recognized that data interface 502 can be implemented with conventional data ports, including any of a parallel port, a serial port, a USB port, and a proprietary data port.

With respect to the disclosure provided above relating to the use of the token and a portable reader, it should be understood that data interface 502, controller 504, memory 506, and timer 508 can be collectively considered as a “token.” Although not like the other types of tokens discussed above, these components interact with a reader that is used to extract data through the data interface and thus to that extent, function like these other types of tokens.

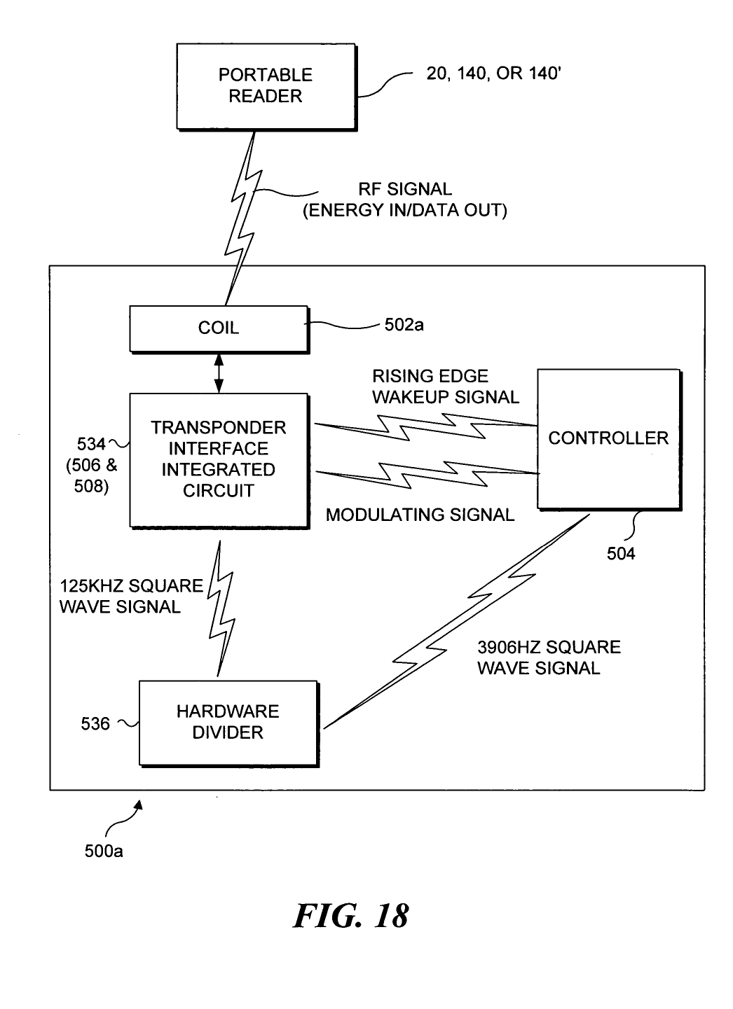

FIG. 18 is a schematic block diagram of a particularly preferred implementation of a metering device 500a, in which the data interface is implemented using a coil. Again, metering device 500a can be considered to be an RFID tag, since it performs a function comparable to an RFID tag. Metering device 500a includes controller 504, which is implemented using a microcontroller. Timer 508, and memory 506 are provided in a commercially available component referred to as a transponder interface integrated circuit 534. Particularly preferred transponder interfaces, such as types U3280M or U3280B, are available from Amtel Corp. of San Jose, California. Amtel also provides a transponder interface that includes an integrated controller, the U9280M-H, which would avoid the need for separate controller 504. It should be understood that similar products from other vendors can be employed, and the present invention is not limited to a specific transponder interface integrated circuit.

Referring to FIG. 18, a coil 502a (capable of inductively coupling to a reader disposed within about five inches, via backscatter modulation) is employed to implement the data interface, as noted above. The memory of the transponder interface stores machine instructions, which went executed by the controller enable the controller to implement the plurality of functions described above. Preferably, the memory of the transponder also stores a unique identification number for the vehicle/equipment (i.e., the VIN), so that data from a plurality of different vehicles/equipment can be collected and distinguished from one another. A portable reader (i.e., any of portable devices 20, 140, or 140) transmits a radio frequency (RF) signal to coil 502a, and the coil conveys content of the RF signal to transponder interface integrated circuit 534. In response to receiving the content of the RF signal from the coil, transponder interface integrated circuit 534 generates an NGAP signal, or a rising edge signal, which is conveyed to controller 504 to wake up the controller. Controller 504 in turn produces a modulating signal that is conveyed back to transponder interface integrated circuit 534. The transponder interface integrated circuit also generates a 125 kHz square wave signal, which is input to a hardware divider 536. The hardware divider divides the 125 kHz square wave by 32 to generate a 3,906 Hz square wave signal, which is supplied to controller 504. By using the clocking function of transponder interface integrated circuit 534 and modulating data with the 3,906 Hz signal, an RF signal is supplied to coil 502a and transmitted thereby to the portable reader, so that the data collected and stored by metering device 500a can be extracted by the portable reader.

Method of Using the Engine Metering Device

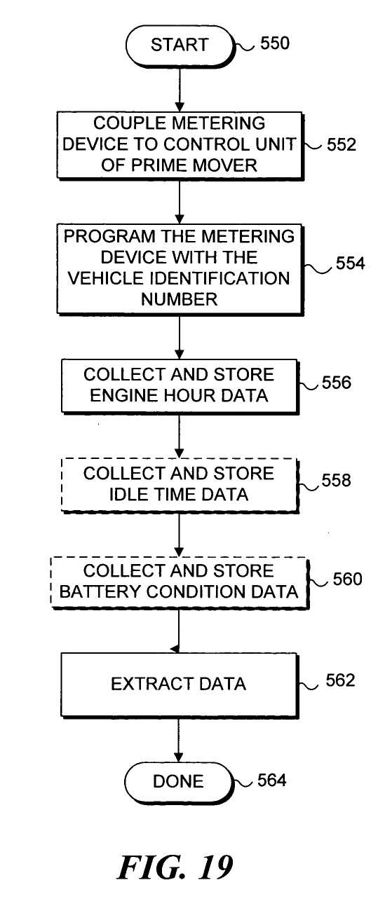

FIG. 19 is a flow chart schematically illustrating a sequence of logical steps employed in using the metering device of FIG. 17 to collect and store engine hour data (and idle time data and/or battery condition data, where the processor is configured to implement the collection and storage of these additional data). From a start block 550, a first step is to install metering device 500 in a vehicle or piece of equipment, as indicated in a block 552. It is contemplated that the metering device of the present invention will be particularly useful in collecting data for fleet vehicles and construction equipment (such as graders, bulldozers, backhoes, etc.), although it should be recognized that these applications are simply exemplary, and that the present invention is not limited to be used with any specific type of vehicle or equipment. In a particularly preferred embodiment, the metering device can simply be installed using three wires, as explained above.

The metering device can be mounted or disposed anywhere within an interior of the vehicle/equipment, or anywhere upon the exterior of the vehicle/equipment, depending on the needs of the user. If the housing of the metering device is not weather proof, the metering device will preferably be placed within a protected location, such as in the cab of the vehicle (or piece of equipment). Placing the metering device in a secured location within a vehicle will reduce the likelihood that the metering device would become damaged, stolen, or be subject to tampering. However, there are also compelling reasons for placing the metering device outside of the cab of a vehicle. Particularly in environments where it would be desirable to collect engine hour and other data from a number of vehicles (or pieces of equipment) in rapid succession, it would be more efficient if the individual tasked with collecting the data simply had to position a reader proximate an external portion of the vehicle where the metering device is disposed. If the metering device were disposed inside the vehicle, it is likely that the person tasked with collecting the data would require a key in order to unlock the vehicle. Particularly in a fleet environment, vehicle keys are likely stored in a secure location remote from the vehicle. If the person tasked with collecting the data must first retrieve these keys, the individual would need to first go to the location where the keys are stored, visit each vehicle, unlock each vehicle, extract the data, lock the vehicle, and then return all of the keys to the remote secure location. If however, the metering device is disposed externally, then the individual tasked with extracting the data would not be required to first retrieve the vehicle keys and could simply walk to each vehicle for which data were to be extracted, which is a significantly more efficient process. Of course, if the metering device is to be installed externally of the vehicle (or piece of equipment), then the housing should be waterproof, and preferably shockproof. Such housings are readily available.

Referring once again to FIG. 19, once the metering device is installed in a vehicle or piece of equipment, the metering device is preferably programmed to store a unique identification number, as indicated in a block 554, to enable data from different metering devices to be collected and then correlated with each specific vehicle or piece of equipment. In general, the unique identification number will be the VIN already assigned to the vehicle; however, it should be understood that any unique identification number could be assigned in the alternative. It should also be understood that this unique identification number could be programmed into and stored within the metering device before the metering device is actually installed in/on the vehicle or piece of equipment, as long as that unique identification number is available ahead of time. Furthermore, while the use of a unique identification number represents a particularly preferred embodiment, it will be appreciated that storing an identification number in the metering device is not required.

In a block 556, the metering device collects and stores engine hour data whenever the ignition system is in the switched power position, generally as described above. Optionally, if the vehicle or piece of equipment includes one or more idle time sensors, idle time data can be collected and stored as indicated in a block 558, enabling an even more accurate picture of vehicle/equipment usage to be provided. For example, assuming that the metering device has been incorporated into a bulldozer being used for road construction, during the morning hours, the bulldozer needs to stop periodically to allow traffic to pass by a construction site. A comparison of the engine hour data and the idle time data enables a determination to be made as to how efficiently the bulldozer has been employed (a longer idle time indicates less efficient utilization). Optionally, battery condition data can be collected and stored by the metering device, as indicated in a block 560. As discussed above, the controller in the metering device can be configured to periodically collect battery condition data (i.e., battery voltage data) whenever the ignition switch is in the off position. While such data are expected to be useful, it should be understood that programming a controller employed in the metering device of the present. invention to collect such data is an exemplary optional function, and should be viewed as limiting the scope of the present invention.

After data have been collected, a portable reader, such as any of those described above, can be used to extract the data from the metering device, as indicated in a block 562. The operator collecting the data will position portable reader at a predetermined distance from the metering device and extract the data, regardless of whether the ignition system is in an off position, an accessory position, or a switched power position. The operator collecting the data is thus not required to have the key that is used to start the vehicle or piece of equipment. Once the data have been collected, the sequence of steps is complete, as indicated in a block 564.

Note that the specific steps implemented by an operator collecting the data will depend on the type of data interface employed in the metering device. The type of data interface employed in the metering device will also determines the type of portable reader employed to extract the data. For example, in a particularly preferred embodiment, the data interface of the metering device comprises an RFID tag so that data can be exported from the metering device so long as a portable reader (generally consistent with a portable readers described above) is disposed proximate the metering device. If the metering device includes a data interface comprising an IBUTTON™ , a reader configured to extract data from an IBUTTON™ will be required (and generally, a physical contact is required between the IBUTTON™ and the reader). If the data interface is as a parallel port, a serial port, or a USB port, then the reader will require a corresponding data connection through a corresponding cable.

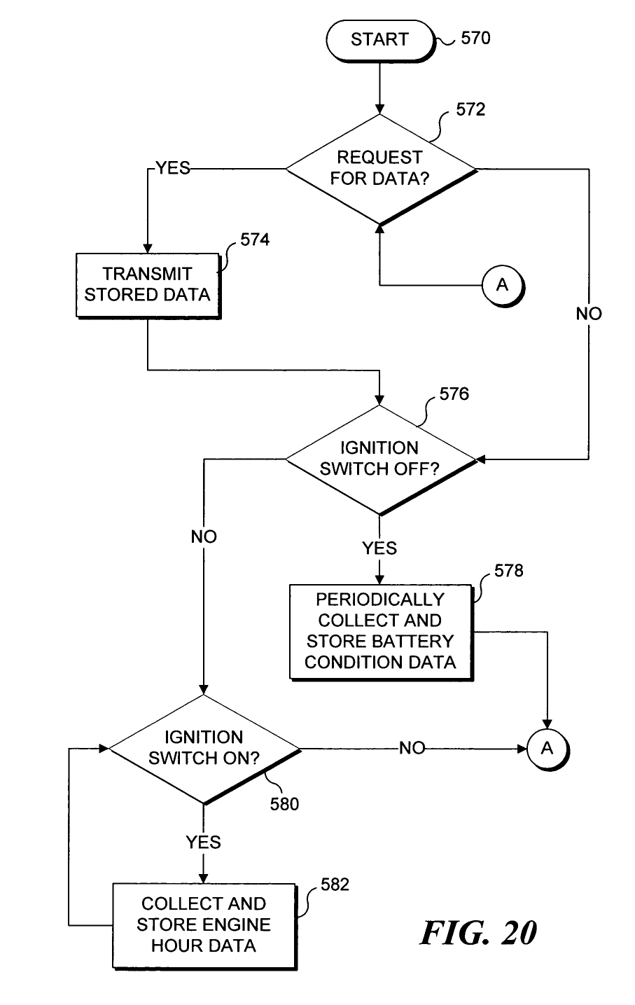

FIG. 20 schematically illustrates a sequence of logical steps implemented by the controller of the metering device of FIG. 17. It should be understood that these steps are merely exemplary, and other sequences of logical steps can be used to generally implement similar functions. Accordingly, the present invention is not limited to only the sequence of steps indicated in FIG. 20. The logical steps are initiated at a start block 570, after the metering device has been installed in/on a vehicle or piece of equipment. In a decision block 572, the processor determines whether a request for data has been received. If so, then data stored in the metering device are transmitted to the reader requesting the data, as indicated in a block 574. If not, the processor then determines whether the ignition switch is an off position, as indicated in a decision block 576. When the ignition switch is in the off position, the processor will periodically collect and store battery voltage data, as indicated in a block 578. The logic then loops back to decision block 572, to determine if a request for data has been received. In a preferred embodiment, battery voltage data will be collected approximately every 30 minutes, although this time period is merely exemplary and is not intended to limit the scope of the invention. If, in decision block 576, it is determined that the ignition switch is not in the off position, then in a decision block 580, the logic determines whether the ignition switch is in a switched power position (note that some ignitions systems have an accessory position, which represents a position that is neither filly off nor fully on in the switched power position). If the ignition switch is in the switched power position, then engine hour data are collected and stored, as indicated in a block 582. The logic then loops back to decision block 572 to determine if a request for data has been received (note that this loop is performed regardless of whether the ignition switch is in the switched power position, as determined in decision block 580).

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

1. A metering device adapted to be logically coupled to a control unit used to selectively energize a prime mover, the metering device being configured to provide and store data that can be used to determine how long the prime mover has been energized and comprising:
(a) a memory for storing the data that can be used to determine how long the prime mover has been energized;
(b) a data interface enabling the data to be extracted from the metering device;
(c) a timer adapted to provide a time signal; and
(d) a controller logically coupled to the memory, the data interface, and the timer and configured to be coupled to a power supply, the controller being configured to implement the following functions:
(i) determining when the control unit is in a state indicating that the prime mover is energized;
(ii) using the time signal from the timer while the control unit is in a state indicating that the prime mover is energized to generate a first type of data that can be used to determine how long the prime mover has been energized;
(iii) storing the first type of data in the memory; and
(iv) responding to a request for data from the data interface by retrieving first type of data from the memory and communicating the retrieved data to the data interface for extraction.

2. The metering device of claim 1, wherein the data interface comprises a radio frequency identification tag.

3. The metering device of claim 1, wherein the data interface comprises a data port adapted to be physically connected to a portable device used to extract the data from the metering device.

4. The metering device of claim 1, wherein the controller is further configured to respond to a single request for data by providing a plurality of different types of data for extraction from the data interface.

5. The metering device of claim 1, wherein the controller comprises at least one of:
(a) a microprocessor that executes a plurality of machine instructions stored in the memory; and
(b) an application specific integrated circuit.

6. The metering device of claim 1, wherein the control unit comprises an ignition switch, and wherein the state indicating that the prime mover is energized comprises a switched power position.

7. The metering device of claim 1, wherein the controller is configured to provide and store the first type of data with a resolution of at least about six minutes.

8. The metering device of claim 1, wherein the controller is further configured to determine when the control unit is in a state indicating that the prime mover is not energized, and when the control unit is in the state indicating that the prime mover is not energized, the controller further implements the following functions:
(a) determining a voltage of a power supply associated with the prime mover; and
(b) storing the voltage so determined in the memory as a second type of data.

9. The metering device of claim 8, wherein the controller further implements the following functions:
(a) periodically determining a current voltage of the power supply associated with the prime mover;
(b) comparing the current voltage with the second type of data stored in the memory, and if the current voltage is lower than the voltage that is stored and corresponds to the second type of data, replacing the voltage that is stored in the memory as the second type of data with the current voltage; and
(c) responding to a request for data from the data interface by retrieving the second type of data from the memory and communicating the second type of data that was retrieved to the data interface for extraction.

10. The metering device of claim 1, wherein the controller is adapted to enable the data to be extracted when the prime mover is not energized.

11. The metering device of claim 1, wherein the control unit is an ignition switch, and the controller is adapted to enable the data to be extracted when the ignition switch is in an off position.

12. The metering device of claim 1, further comprising an idle time sensor logically coupled to the controller that enables an idle time to be determined by the controller, thereby enabling the idle time to be stored in the memory as a third type of data.

13. The metering device of claim 12, wherein the idle time sensor comprises at least one of a driveline sensor, an inductive pickup sensor, and a neutral switch sensor.

14. The metering device of claim 1, wherein the controller receives an input from an idle time sensor that is logically coupled to the controller, the controller further implementing the following functions:
(a) using the time signal from the timer and the input from the idle time sensor to generate a third type of data that indicates how long the prime mover has been energized and idle;
(b) storing the third type of data in the memory; and
(c) responding to a request for data from the data interface by retrieving the third type of data from the memory and communicating the third type data that was retrieved to the data interface for extraction.

15. The metering device of claim 1, further comprising a housing enclosing the memory, the data interface, the timer, and the controller.

16. The metering device of claim 1, wherein the memory, the data interface, and the controller collectively comprise a token adapted to interact with a reader.

17. The metering device of claim 1, wherein the data comprise engine hour data and at least one of:
(a) identification data;
(b) idle time data; and
(c) battery voltage data.

18. A method for collecting data corresponding to an operational status of a prime mover included on one of a vehicle and equipment, comprising the steps of:
(a) providing a metering device that is adapted to be logically coupled to a control unit used to selectively energize a prime mover;
(b) coupling the metering device to the control unit of the prime mover such that the metering device is enabled to produce and store data corresponding to the operational status of the prime mover when the control unit is in a position in which the prime mover is energized, the data being indicative of how long the prime mover has been energized; and
(c) extracting the data from the metering device.

19. The method of claim 18, further comprising the step of including an identification of said one of the vehicle and equipment within the data.

20. The method of claim 18, wherein the control unit comprises an ignition switch, and the step of extracting the data further comprises extracting the data when the ignition switch is in an off position.

21. The method of claim 18, wherein the step of extracting the data comprises the step of extracting the data using a portable reader.

22. The method of claim 18, wherein the step of extracting the data comprises the step of extracting a plurality of different types of data based on a single request for data.

23. The method of claim 18, wherein the data further indicates how long the prime mover has been energized but idle.

24. A method for collecting data enabling indicative of how long a prime mover has been energized, comprising the steps of:
(a) collecting data when a control unit configured to selectively energize the prime mover is in a position indicative of the prime mover being energized;
(b) storing the data in a memory; and
(c) extracting the data from the memory, when the prime mover is not energized and when the control unit is in an off position.

25. The method of claim 24, wherein the step of extracting the data comprises the step of transmitting a plurality of different types of data in response to a single request for data.

26. The method of claim 24, wherein the step of extracting the data further comprises the step of extracting data corresponding to an idle time.

27. The method of claim 24, wherein the step of extracting the data further comprises the step of extracting data indicative of a condition of a battery associated with the prime mover.

28. The method of claim 24, wherein the step of extracting the data further comprises the step of extracting the data using a radio frequency communication.

29. The method of claim 24, further comprising the steps of:
(a) collecting idle time data produced using an idle time sensor; and
(b) storing the idle time data in the memory, such that the step of extracting the data further comprises the step of extracting the idle time data.

30. The method of claim 24, further comprising the steps of:
(a) periodically collecting battery voltage data from a battery associated with the prime mover when the control unit is not in a position to enable the prime mover to be energized; and
(b) storing the battery voltage data in the memory, such that the step of extracting the data further comprises the step of extracting the battery voltage data.
